(19) United States
(12) Patent Application Publication
(10) Pub. No.: US 2012/0086885 A1
(43) Pub. Date: Apr. 12, 2012

(54) LIGHTING DEVICE, DISPLAY DEVICE AND TELEVISION RECEIVER

(75) Inventor: Masashi Yokota, Osaka-shi (JP)

(73) Assignee: SHARP KABUSHIKI KAISHA, Osaka-shi, Osaka (JP)

(21) Appl. No.: 13/376,196

(22) PCT Filed: Apr. 6, 2010
(86) PCT No.: PCT/JP2010/056212

§ 371 Date: Dec. 5, 2011

(30) Foreign Application Priority Data
Jun. 15, 2009 (JP) 2009-142490

(51) Int. Cl. G02F 1/1335; F21V 13/04; F21V 7/00

(52) U.S. Cl. 349/61; 362/296.01; 362/235; 362/308; 362/297; 362/299

(57) ABSTRACT

An object of the present invention is to suppress deformation of a reflection member. A backlight unit 12 according to the present invention includes a light source board 18, a chassis 14, and a reflection sheet 21. The light source board 18 includes an LED 17 as a light source. The chassis 14 stores the light source board 18 therein and has an opening 14b through which light from the LED 17 exits. The reflection sheet 21 that is a reflection member configured to reflect light and arranged on the opening 14b side so as to overlap the light source board 18 in a plan view. The reflection sheet 21 is larger than the light source board 18. The chassis 14 has a first supporting portion 28 and a second supporting portion 29. The first supporting portion 28 supports the light source board 18. The second supporting portion 29 is arranged closer to the opening 14b than the first supporting portion 28, and supports a first reflection sheet 22 included in the reflection sheet 21.

### TECHNICAL FIELD

The present invention relates to a lighting device, a display device and a television receiver.

### BACKGROUND ART

For example, a liquid crystal panel used for a liquid crystal display device such as a liquid crystal television set does not emit light by itself, and therefore, requires a separate backlight unit as a lighting device. This backlight unit is installed on the back side of the liquid crystal panel (the side opposite to a display surface), and includes a chassis having an opened surface on the liquid crystal panel side, a light source stored in the chassis, a reflection sheet that is arranged in the chassis and reflects light toward an opening of the chassis, and an optical member (diffuser sheet or the like) that is arranged at the opening of the chassis and efficiently discharges light toward the liquid crystal panel. Among the above-mentioned components of the backlight unit adopts, as the light source, an LED for example, and in such case, an LED board that mounts the LED thereon is stored in the chassis.

An example of the backlight unit using the LED as the light source is described in Patent Document 1.

### PRIOR ART DOCUMENT

### Patent Document

Patent Document 1: Japanese Unexamined Patent Publication No. 2007-317423

### PROBLEM TO BE SOLVED BY THE INVENTION

When an LED board covering the entire chassis is used for the backlight unit, material costs increase and therefore, for example, it is preferable to intermittently arrange a plurality of strip-like LED boards. However, when each LED board is arranged in the chassis, a step corresponding to the thickness of the LED board is generated between an inner surface of the chassis and each LED board. On the contrary, since the reflection sheet arranged along the inner surface of the chassis is covered on the front side of the LED board, that is, the side of the opening, a gap is generated between the reflection sheet and the inner surface of the chassis due to the step. Since the reflection sheet has the area supported by the LED board and the area that is not supported by the LED board and the chassis in this manner, stress tends to concentrate at a boundary between the areas, thereby possibly causing local deformation in the reflection sheet. When such deformation in the reflection sheet occurs, unevenness of reflected light occurs and uneven brightness of illumination light from the optical member also occurs, disadvantageously lowering display quality.

### DISCLOSURE OF THE PRESENT INVENTION

The present invention is made in view of the above-mentioned circumstances and its object is to suppress deformation in the reflection member.

A lighting device according to the present invention includes a light source board, a chassis, and a reflection member. The light source board includes a light source. The chassis stores the light source board therein and has an opening through which light from the light source exits. The reflection member is arranged on an opening side so as to overlap the light source board in a plan view. The reflection member is larger than the light source board and configured to reflect light. The chassis has a first supporting portion and a second supporting portion. The first supporting portion supports the light source board. The second supporting portion is arranged closer to the opening than the first supporting portion and supports the reflection member.

With this configuration, an area of the reflection member overlapping the light source board from the opening side is supported by the light source board. An area of the reflection member not overlap the light source board is supported by the second supporting portion arranged closer to the opening than the first supporting portion that supports the light source board. Accordingly, it is prevented that stress concentrates on the boundary between the area of the reflection member overlapping light source and the area of the reflection member not overlapping the light source board. As a result, deformation of the reflection member is less likely to occur.

### BRIEF DESCRIPTION OF THE DRAWINGS

FIG. 1 is an exploded perspective view showing a schematic configuration of a television receiver according to a first embodiment of the present invention;

FIG. 2 is an exploded perspective view showing a schematic configuration of a liquid crystal display device provided in the television receiver;

FIG. 3 is a plan view showing an arrangement of LED boards and holding members in a chassis of the liquid crystal display device;

FIG. 4 is a sectional view taken along line iv-iv in FIG. 3 of the liquid crystal display device;

FIG. 5 is a sectional view taken along line v-v in FIG. 3 of the liquid crystal display device;

FIG. 6 is a plan view showing a detailed arrangement of the LED boards and the holding members;

FIG. 7 is a sectional view taken along line vii-vii in FIG. 6;

FIG. 8 is a sectional view taken along line viii-viii in FIG. 6;

FIG. 9 is a sectional view taken along line ix-ix in FIG. 6;

FIG. 10 is a plan view of the LED board;

FIG. 11 is a plan view showing the state where a second reflection sheet and diffuser lenses are attached to the LED board (light source unit);

FIG. 12 is a plan view of a monofunctional holding member;

FIG. 13 is a bottom view of the monofunctional holding member;

FIG. 14 is a plan view of a multifunctional holding member;

FIG. 15 is a bottom view of the multifunctional holding member;

FIG. 16 is a bottom view of a chassis;

FIG. 17 is a partially enlarged sectional view taken along line iv-iv in FIG. 3 showing the liquid crystal display device;

FIG. 18 is a sectional view showing relationship among second supporting portions, the LED board and each reflection sheet according to a first modification example of the first embodiment;

FIG. 19 is a sectional view showing relationship among the second supporting portions, the LED board and each reflection sheet according to a second modification example of the first embodiment;

FIG. 20 is a sectional view showing relationship among the second supporting portions, the LED board and each reflection sheet according to a second embodiment of the present invention;

FIG. 21 is a sectional view showing relationship among the second supporting portions, the LED board and each reflection sheet according to a third embodiment;

FIG. 22 is a sectional view showing the diffuser lenses and the LEDs together with the second supporting portions and the like;

FIG. 23 is a sectional view showing relationship among the second supporting portions, the LED board and each of the reflection sheets in a first modification example of the third embodiment;

FIG. 24 is an enlarged sectional view taken along the long-side direction showing the liquid crystal display device according to a fourth embodiment of the present invention;

FIG. 25 is a sectional view of a backlight unit according to a fifth embodiment of the present invention;

FIG. 26 is a sectional view showing the state where a holding member is attached to the chassis; and

FIG. 27 is a sectional view showing a backlight unit according to a sixth embodiment of the present invention.

### BEST MODE FOR CARRYING OUT THE INVENTION

### First Embodiment

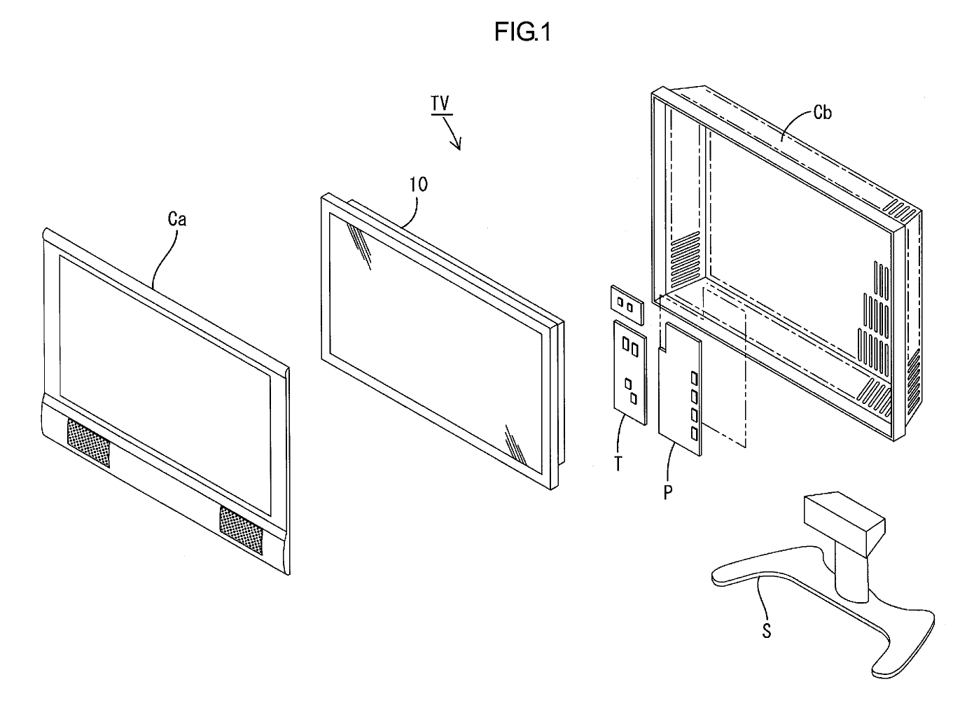

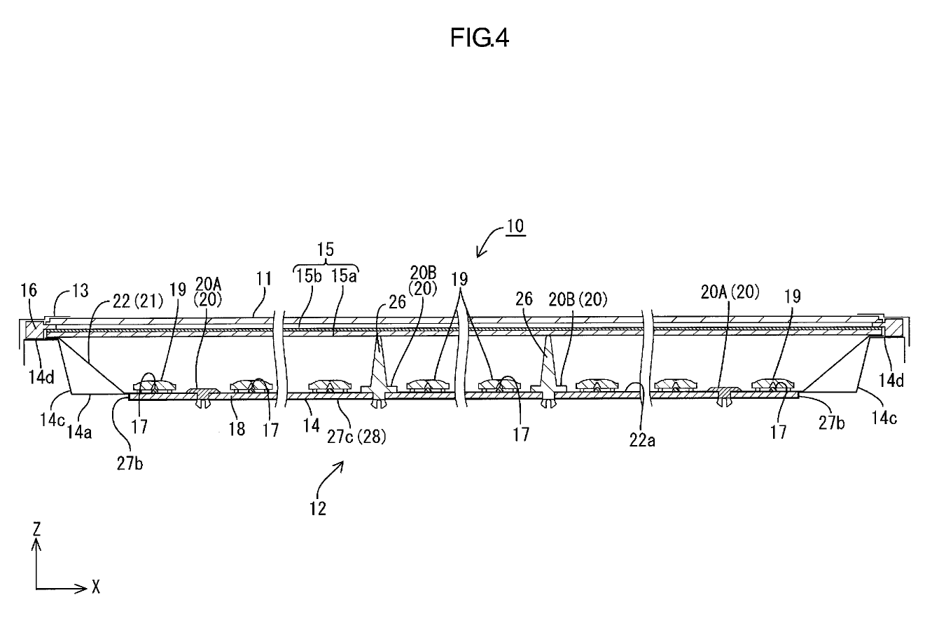

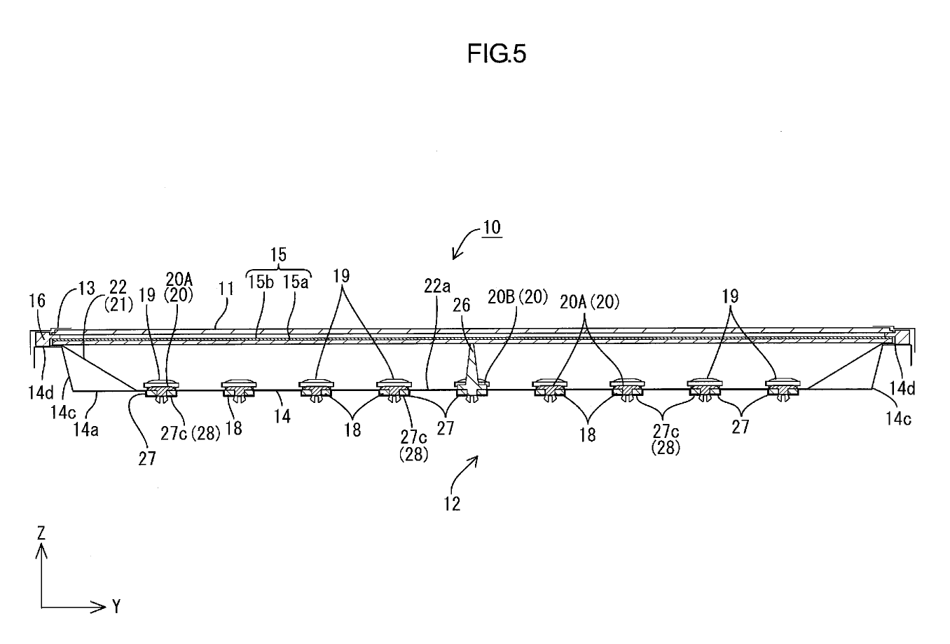

A first embodiment of the present invention will be described with reference to FIGS. 1 to 17. In this embodiment, a liquid crystal display device 10 is used as an example. A part of each figure shows an X-axis, a Y-axis and a Z-axis, and a direction of each axis is represented in each figure. It is given that an upper side in FIGS. 4 and 5 is a front side and a lower side in these figures is a backside.

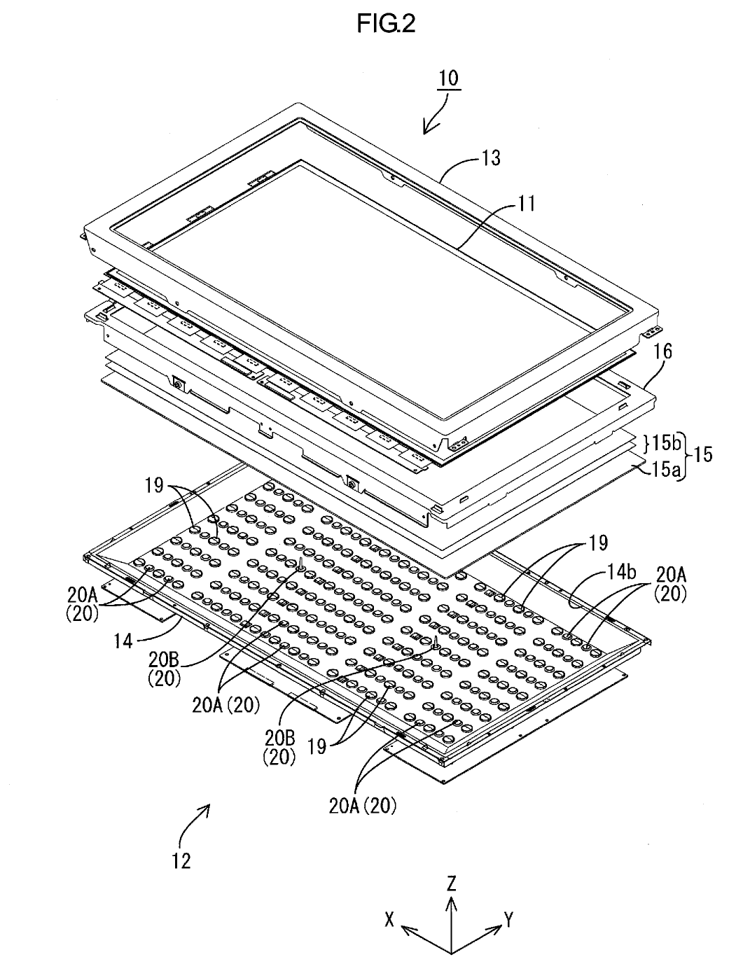

A television receiver TV according to this embodiment includes, as shown in FIG. 1, the liquid crystal display device 10, front and back cabinets Ca, Cb that store the liquid crystal display device 10 therebetween, a power source P, a tuner T and a stand S. The liquid crystal display device (display device) 10 is shaped like an oblong quadrangle as a whole (rectangular) and is stored in a longitudinally mounted state. The liquid crystal display device 10 includes, as shown in FIG. 2, a liquid crystal panel 11 as a display panel and a backlight unit (lighting device) 12 as an external light source, and these components are integrally held by a frame-like bezel 13 or the like. In this embodiment, it is assumed that a screen size is 42 inches and an aspect ratio is 16:9.

Next, the liquid crystal panel 11 and the backlight unit 12 that constitute the liquid crystal display device 10 will be successively described. The liquid crystal panel (display panel) 11 among them is rectangular in a plan view, and is formed by sticking a pair of glass substrates to each other with a predetermined gap therebetween and filling a liquid crystal between the both glass substrates. One glass substrate has a switching component (for example, TFT) connected to a source wiring and a gate wiring that are perpendicular to each other, a pixel electrode connected to the switching component and an alignment film, and the other glass substrate has a color filter in which color sections of R (red), G (green), B (blue) are arranged in a predetermined pattern, a counter electrode and an alignment film and the like. Polarizing plates are provided outer of the both substrates.

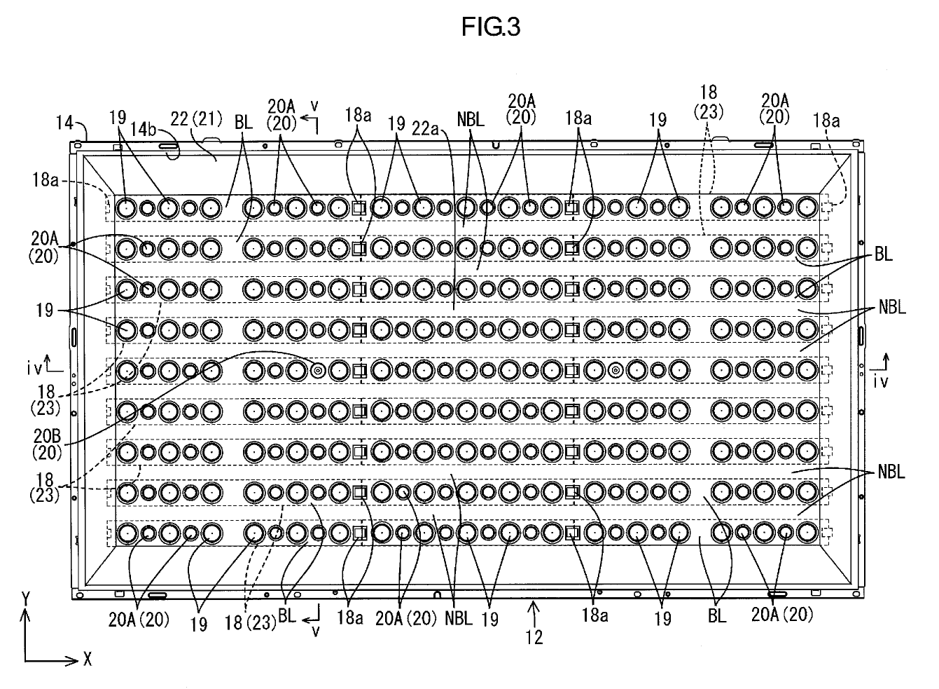

Subsequently, the backlight unit 12 will be described in detail. The backlight unit 12 includes, as shown in FIG. 2, a substantially box-like chassis 14 having openings 14b on the side of a light emitting surface (the side of the liquid crystal panel 11), an optical member group 15 (a diffuser (light diffusing member) 15a, and a plurality of optical sheets 15b arranged between the diffuser 15a and the liquid crystal panel 11) arranged so as to cover the openings 14b of the chassis 14, and a frame 16 that is arranged along an outer edge of the chassis 14 and holds an outer edge of the optical member group 15 between the frame 16 and the chassis 14. The chassis 14 includes, as shown in FIGS. 3 to 5, LEDs 17 (Light Emitting Diode) as light sources, LED boards 18 that mount the LEDs 17 thereon and diffuser lenses 19 attached at positions corresponding to the LEDs 17 on the LED boards 18. The chassis 14 further includes holding members 20 configured to hold the LED boards 18 between the holding members 20 and the chassis 14 and a reflection sheet (reflection member) 21 that reflects light in the chassis 14 toward the optical member 15. In the backlight unit 12, the side of the optical member 15, not the LEDs 17, is set as a light emitting side. Hereinafter, each component of the backlight unit 12 will be described in detail.

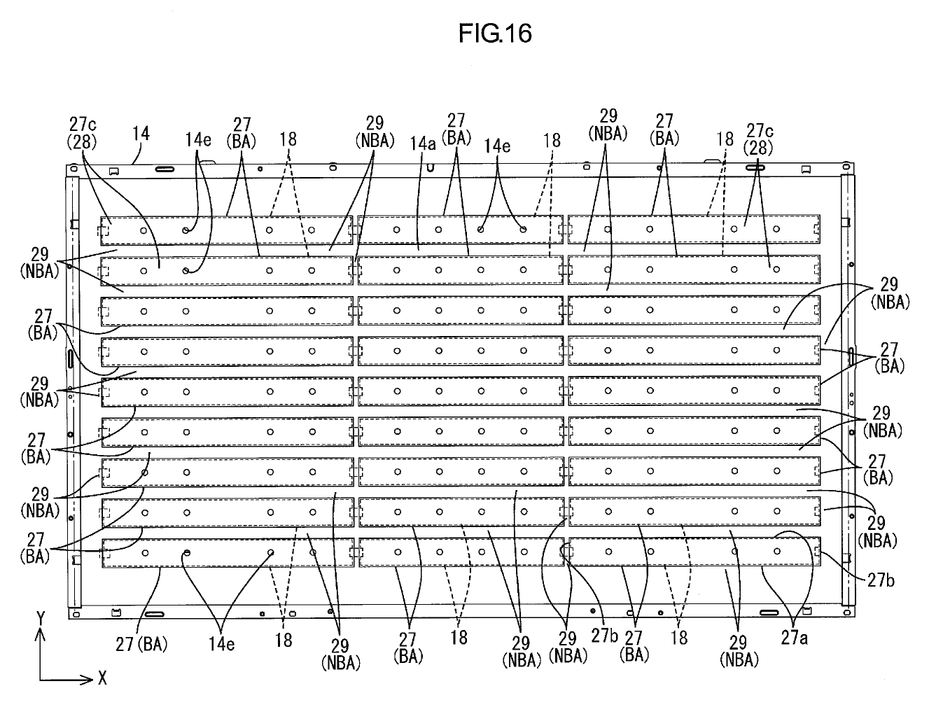

The chassis 14 is made of metal, and as shown in FIGS. 3 to 5, consists of a rectangular bottom plate 14a like the liquid crystal panel 11, side plates 14c rising from outer ends of sides of the bottom plate 14a and receiving plates 14d extending outward from rising ends of the respective side plates 14c, and is shaped like a shallow box (shallow dish) opened toward the front side as a whole. In the chassis 14, its long-side direction corresponds to the X-axis direction (horizontal direction) and its short-side direction corresponds to the Y-axis direction (vertical direction). The bottom plate 14a of the chassis 14 is substantially shaped like a flat plate in parallel to the liquid crystal panel 11 and the optical member 15, and has the same dimension as the liquid crystal panel 11 and the optical member 15 in a plan view. The bottom plate 14a includes on the plane surface thereof a plurality of LED boards 18 intermittently arranged at predetermined intervals in parallel, which will be described in detail later. Accordingly, the bottom plate 14a has board arrangement area BA where the LED boards 18 are arranged and board non-arrangement areas NBA where the LED boards 18 are not arranged (FIGS. 3 and 16). The board arrangement areas BA of the bottom plate 14a have board positioning portions 27 for positioning the LED boards 18 and detail of which will be described later. The frame 16 and the optical member 15 described below can be mounted on each receiving plate 14d of the chassis 14 from the front side. The frame 16 is screwed into each receiving plate 14d. The bottom plate 14a includes opened attachment holes 14e for attaching the holding members 20. The plurality of attachment holes 14e is arranged at attachment positions of the holding members 20 on the bottom plate 14a, and detailed arrangement of the attachment holes and the board positioning portion 27 will be described later.

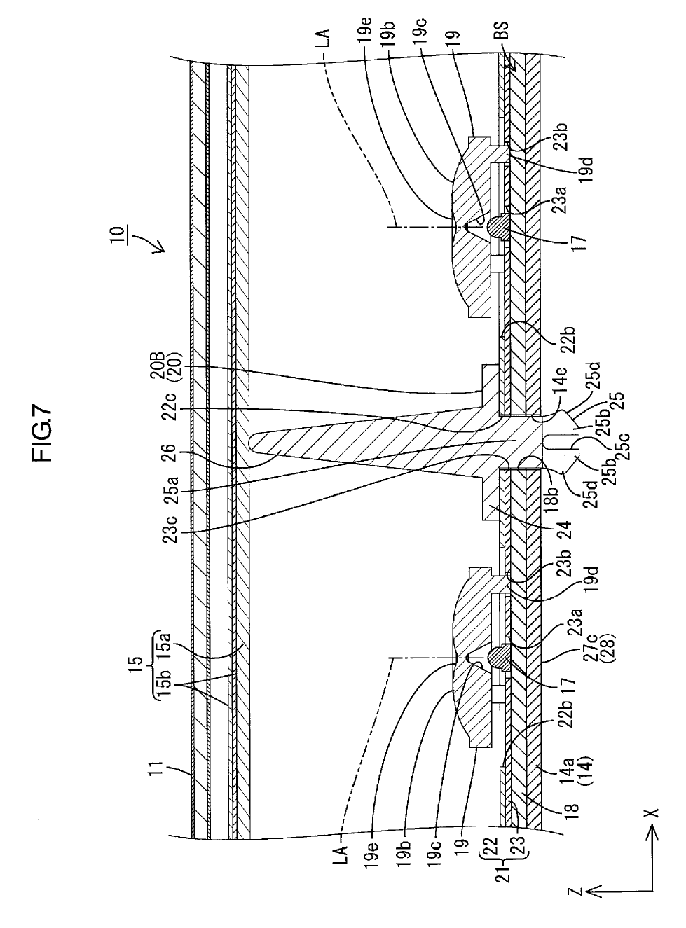

As shown in FIG. 2, like the liquid crystal panel 11 and the chassis 14, the optical member 15 is shaped like an oblong quadrangle (rectangular) in a plan view. As shown in FIGS. 4 and 5, the optical member 15 covers the openings 14b of the chassis 14 by placing its outer edge on the receiving plates 14d, and is interposed between the liquid crystal panel 11 and the LEDs 17. The optical member 15 consists of the diffuser 15a arranged on the back side (the side of the LEDs 17, the side opposite to the light-emitting side) and the optical sheets 15b arranged on the front side (the side of the liquid crystal panel 11, the light-emitting side). The diffuser 15a is formed by dispersing multiple diffusing particles in a substantially transparent resin base member having a predetermined thickness and has a function of diffusing transmitted light. The optical sheet 15b is shaped like a thinner sheet than the diffuser 15a and two sheets are laminated (FIGS. 7 to 9). Specific examples of the optical sheets 15b include diffuser sheets, lens sheets, reflection type polarizing sheets, and it is possible to select and use any of these sheets as appropriate.

As shown in FIG. 2, the frame 16 is shaped like a frame along outer circumferences of the liquid crystal panel 11 and the optical member 15. The outer edge of the optical member 15 can be pinched between the frame 16 and each of the receiving plates 14d (FIGS. 4 and 5). The frame 16 can receive the outer edge of the liquid crystal panel 11 from the backside and pinch the outer edge of the liquid crystal panel 11 between the frame 16 and the bezel 13 arranged on the front side (FIGS. 4 and 5).

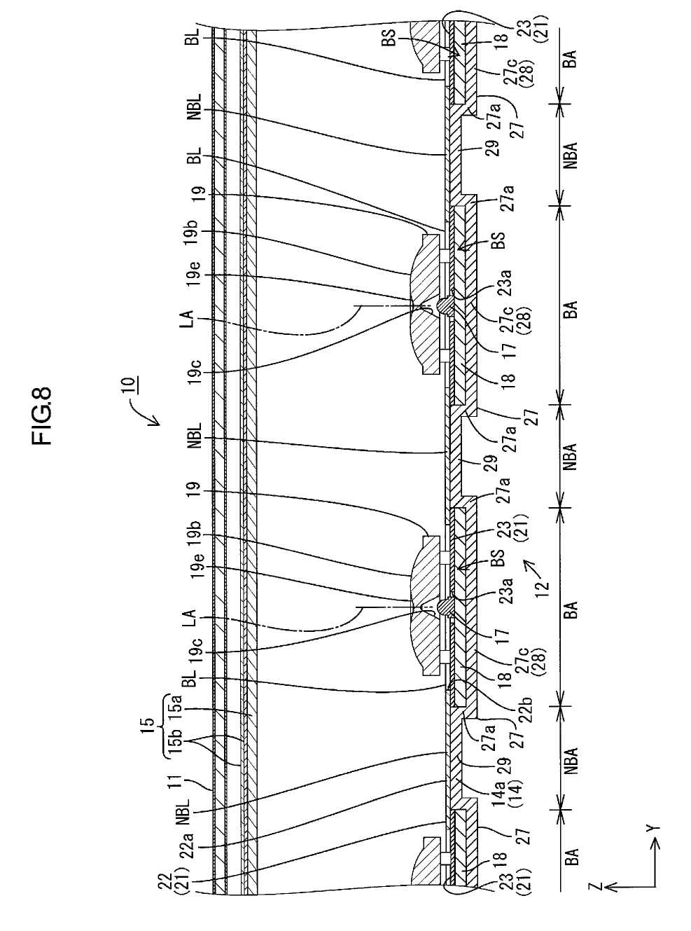

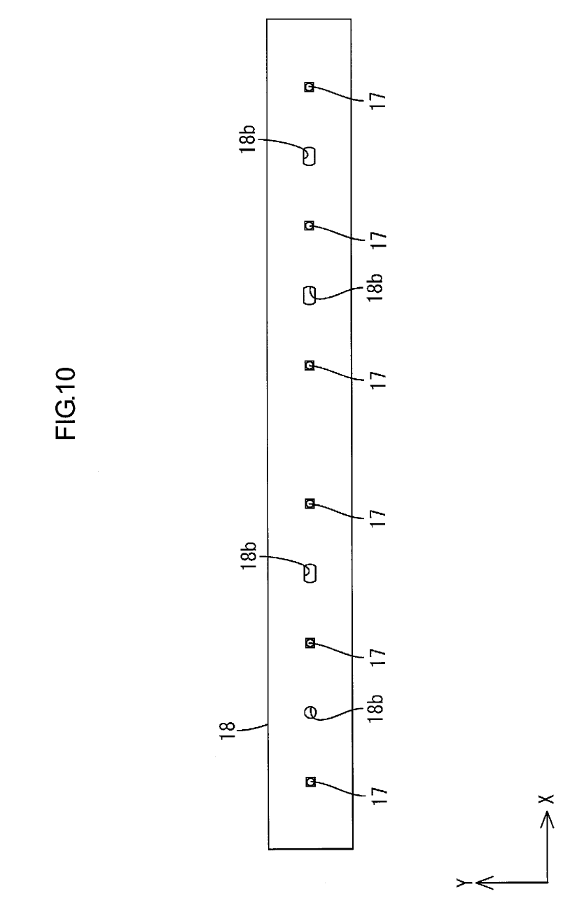

Next, the LEDs 17 and the LED boards 18 that mount the LEDs 17 thereon will be described in detail. As shown in FIG. 7, FIG. 8 and FIG. 10, each of the LEDs 17 is formed by sealing an LED chip on a board portion fixedly attached to the LED board 18 with a resin material. The LED chip mounted on the board portion has one type of main light-emitting wavelength, and specifically, emits only blue light. Meanwhile, phosphors converting blue light emitted by the LED chip into white light are dispersedly mixed in the resin material sealing the LED chip. Thereby, the LED 17 can emit white light. This LED 17 is a so-called top type in which a surface on the side opposite to the mounting surface of the LED board 18 acts as a light-emitting surface. An optical axis LA in the LED 17 substantially corresponds to the Z-axis direction (the direction perpendicular to the liquid crystal panel 11 and a main plate surface of the optical member 15). Light emitted from the LEDs 17 extends radially to some extent about the optical axis LA within a predetermined angular range in a three-dimensional way, and has a higher directivity than light from a cold cathode tube. That is, the light emission intensity of the LED 17 becomes remarkably high in a direction along the optical axis LA and rapidly lowers as inclination angle relative to the optical axis LA is larger.

As shown in FIG. 10, the LED board 18 has a rectangular (strip-like) base material in a plan view, extends along the bottom plate 14a and is stored in the chassis 14 so that its long-side direction matches the X-axis direction and its short-side direction matches the Y-axis direction (FIG. 3). The base member of the LED board 18 is made of metal such as aluminum material that is the same as the material for the chassis 14, and has a surface on which a wiring pattern formed of a metal film such as a copper foil is formed via an insulating layer. Insulating materials such as ceramic can be used as the material for the base member of the LED board 18. As shown in FIG. 7, FIG. 8 and FIG. 10, the LEDs 17 having the above-mentioned configuration are mounted on a surface facing the front side (surface facing the optical member 15 side) among surfaces of the base member of the LED board 18. The plurality of LEDs 17 is linearly arranged along the long-side direction of the LED boards 18 (X-axis direction) in parallel, and is serially connected according to the wiring pattern formed on the LED boards 18. The alignment pitch of the LEDs 17 is almost constant, that is, the LEDs 17 are arranged at regular intervals. Each of the LED boards 18 has a connector portion 18a at both ends thereof in the long-side direction.

As shown in FIG. 3, the LED boards 18 having the above-mentioned configuration is arranged in the chassis 14 in each of the X-axis direction and the Y-axis direction so that the LED boards 18 are aligned in the long-side direction and the short-side direction in parallel. That is, the LED boards 18 and the LEDs 17 mounted thereon are arranged in the chassis 14 in a matrix having the X-axis direction (the long-side direction of the chassis 14 and the LED board 18) as a row direction and the Y-axis direction (the short-side direction of the chassis 14 and the LED board 18) as the column direction. Specifically, the three LED boards 18 in the X-axis direction×the nine LED boards 18 in the Y-axis direction, that is, 27 LED boards 18 in total are arranged in the chassis 14 in parallel. In this embodiment, two types of LED boards 18 having different long-side dimensions and the number of mounted LEDs 17 are used. Specifically, a six-mounted type of the LED board 18 that mounts the six LEDs 17 thereon and has a relatively long long-side dimension and a five-mounted type of the LED board 18 that mounts the six LEDs 17 thereon and has a relatively short long-side dimension are used as the LED boards 18, and the six-mounted type of the LED board 18 is arranged at each end of the chassis 14 in the X-axis direction and the five-mounted type of the LED board 18 is arranged at the center in the same direction. As described above, the LED boards 18 aligned in one row in the X-axis direction are electrically connected to each other by fitting the adjacent connector portions 18a with each other, and the connector portions 18a located at both ends of the chassis 14 in the X-axis direction are each electrically connected to an external control circuit not shown. Thereby, the LEDs 17 arranged on the LED board 18 forming one row are serially connected to one another, so that lighting-on and off of the multiple LEDs 17 contained in the one row can be controlled together by one control circuit, which enables reduction in costs. Even the different types of LED boards 18 having different long-side dimensions and the number of mounted LEDs 17 have the substantially identical short-side dimension and alignment pitch of the LEDs 17. The arrangement of the LED boards 18 with respect to the chassis 14 corresponds to that of the board arrangement areas BA in the bottom plate 14a. Accordingly, the board non-arrangement areas NBA are arranged in the bottom plate 14a in a form of a lattice surrounding each of the board arrangement areas BA in a matrix.

By preparing plural types of LED boards 18 having different long-side dimensions and the number of mounted LEDs 17 and appropriately using the different types of LED boards 18 in combination, following effects can be obtained. In other words, various types of liquid crystal display devices 10 of different screen sizes can be easily manufactured by appropriately selecting use/nonuse of each type of the LED board 18 and changing the number of each type of the LED boards 18 according to each screen size. As compared to the case where the dedicated LED board having the same long-side dimension as the long-side dimension of the chassis 14 is prepared for each screen size, the number of types of necessary LED boards 18 can be greatly reduced and therefore, manufacturing costs can be reduced. Specifically, by adding an eight-mounted type LED board 18 that mounts eight LEDs 17 thereon to the above-mentioned two types of LED boards 18 (the five-mounted type and the six-mounted type) and appropriately using the three types of LED boards 18 in combination, each of the liquid crystal display devices 10 having the screen size of 26 inches, 32 inches, 37 inches, 40 inches, 42 inches, 46 inches, 52 inches and 65 inches can easily be manufactured.

The LED boards 18 arranged in the chassis 14 as described above are positioned in the direction along the plate surface by the above-mentioned board positioning portions 27. The board positioning portion 27 will be described in detail below. As shown in FIGS. 4 and 5, the board positioning portion 27 is formed by partially protruding the bottom plate 14a toward the back side, that is, the side opposite to the opening 14b so as to ensure a board storing space BS that can store the LED board 18 therein from the front side. Describing in detail, the board positioning portion 27 is formed over the almost entirety of each board arrangement area BA of the bottom plate 14a on which each LED board 18 is arranged, thereby holding the board storing space BS. The board positioning portion 27 is shaped by drawing the bottom plate 14a. The board positioning portion 27 has a predetermined width in the Y-axis direction and is shaped like a rail extending substantially linearly in the X-axis direction. That is, the long-side direction and the short-side direction of the board positioning portion 27 correspond to those of the bottom plate 14a. The outer shape of the board positioning portion 27 is rectangular in a plan view, and the outer shape is almost same as that of the LED board 18. That is, the long-side direction and the short-side direction of the board positioning portion 27 have clearance that allows storage of the LED board 18, but are almost same as those of the LED board 18, so that the LED board 18 can be independently stored. As shown in FIGS. 3 and 16, arrangement of the board positioning portions 27 on the bottom plate 14a corresponds to the above-mentioned arrangement of the LED boards 18 on the bottom plate 14a, that is, arrangement of the board arrangement areas BA, and the plurality of board positioning portions 27 is arranged in each of the X-axis direction and the Y-axis direction in a matrix. Describing in detail, the board positioning portions 27 are arranged at predetermined intervals in parallel in the X-axis direction and the Y-axis direction so that their long-side direction and short-side direction align with each other. Specifically, three board positioning portions 27 are arranged in the X-axis direction and nine positioning portions 27 are arranged in the Y-axis direction, that is, 27 positioning portions 27 in total are arranged in a matrix. In the periphery of each of the board positioning portions 27, an undrawn area of the bottom plate 14a, that is, the board non-arrangement area NBA is left, and the board non-arrangement area NBA is shaped like an endless ring surrounding each board positioning portion 27.

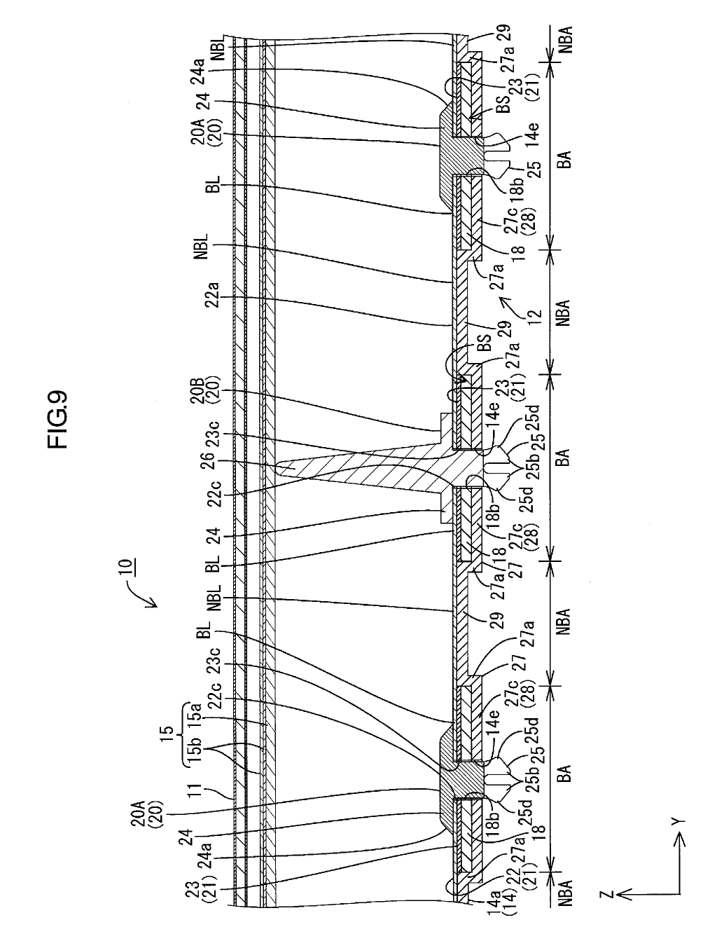

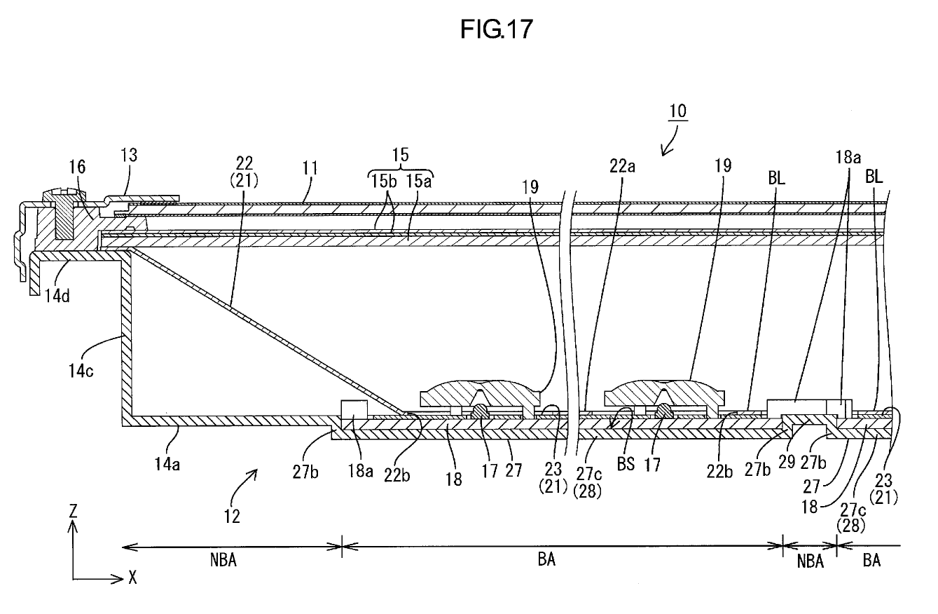

As shown in FIG. 8, FIG. 9 and FIG. 17, the board positioning portion 27 consists of side wall parts 27a and 27b that protrude from the bottom plate 14a toward the back side along the Z-axis direction and a bottom wall part 27c that connects the side wall parts 27a and 27b to each other, and is shaped like a bag opened to the front side as a whole. The sidewall parts 27a and 27b consists of a pair of long-side sidewall parts 27a extending in the X-axis direction (long-side side edge of the LED board 18) and a pair of short-side sidewall parts 27b extending in the Y-axis direction (short-side side edge of the LED board 18). As shown in FIGS. 8 and 9, the long-side sidewall parts 27a are configured to contact with the long-side side edge of the LED board 18, thereby positioning the LED board 18 in the Y-axis direction. As shown in FIG. 17, the short-side sidewall parts 27b are configured to contact with the short-side side edge of the LED board 18, thereby positioning the LED board 18 in the X-axis direction. That is, when being stored in the board storing space BS, the LED board 18 is positioned in the X-axis direction and the Y-axis direction that are perpendicular to each other in a two-dimensional way by the board positioning portion 27.

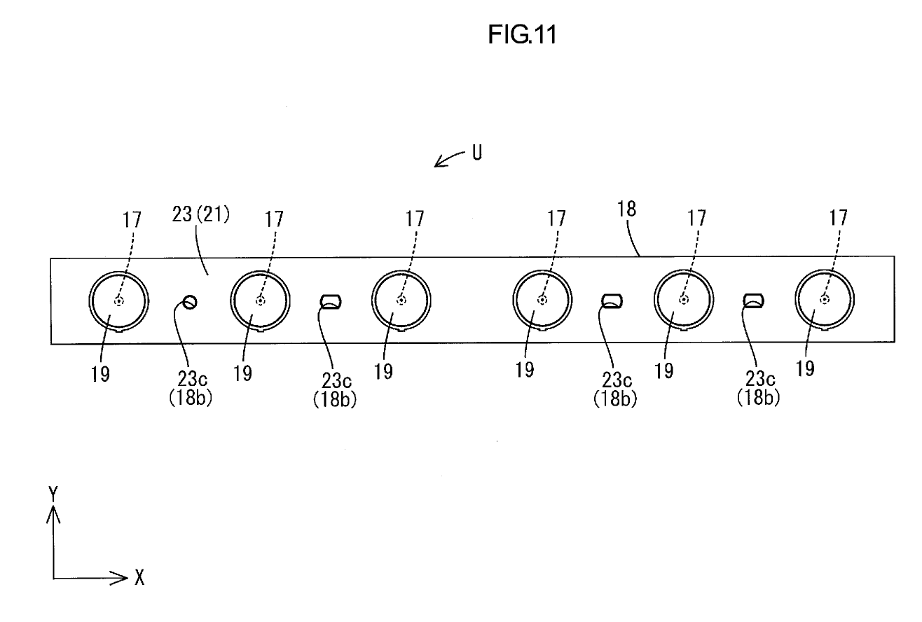

The diffuser lenses 19 are made of a synthetic resin material (e.g. polycarbonate and acrylic) that is substantially transparent (highly light transmissive) and has a higher refractive index than air. As shown in FIG. 7, FIG. 8 and FIG. 11, the diffuser lenses 19 each have a predetermined thickness, are formed to be substantially circular in a plan view, and are attached so as to cover the respective LEDs 17 from the front side of the LED board 18, that is, to overlap with the respective LEDs 17 in a plan view. The diffuser lenses 19 can emit highly directive light from the LEDs 17 while diffusing the light. That is, since directivity of the light emitted from the LEDs 17 is reduced through the diffuser lenses 19, even when the interval of the adjacent LEDs 17 is set large, an area between the LEDs 17 is hard to be visually recognized as a dark place. Thereby, the number of installed LEDs 17 can be reduced. Each diffuser lens 19 is located to be substantially concentric with each LED 17 in a plan view. A diffuser lens 19 has dimension in the X-axis direction and the Y-axis direction that is larger than the LED 17, but is smaller than the LED board 18.

In each of the diffuser lenses 19, a surface that faces the back side and is opposite to the LED board 18 is a light incidence surface 19a on which light from the LED 17 is incident, while a surface that faces the front side and is opposite to the optical member 15 is a light emitting surface 19b. As shown in FIGS. 7 and 8, the light incidence surface 19a extends in parallel to a plate surface of the LED board 18 (the X-axis direction and the Y-axis direction) as a whole, but has an inclined surface obtained by forming a light incidence-side concave portion 19c in an area where the light incidence surface 19a and the LED 17 overlap with each other in a plan view. The light incidence-side concave portion 19c is substantially conical, is located to be almost concentric with the diffuser lens 19 and is opened toward the backside, that is, the LED 17. The light incidence-side concave portion 19c has the largest diameter at its opened end facing the LED 17, which is larger than the diameter of the LED 17, and becomes smaller toward the front side in diameter continually and gradually, and finally becomes the smallest at its end of the front side. The light incidence-side concave portion 19c has a substantially inverted V-shaped cross section and a circumferential surface thereof is inclined relative to the Z-axis direction. The inclined surface is inclined so that the end of the front side crosses the optical axis LA of the LED 17. Accordingly, light emitted from the LED 17 and entering into the light incidence-side concave portion 19c is incident into the diffuser lens 19 through the inclined surface. At this time, the incident light is refracted away from the center, that is, with a wide angle, by an inclined angle of the inclined surface relative to the optical axis LA and is incident into the diffuser lens 19.

The light incidence surface 19a of the diffuser lens 19 has attachment shaft portions 19d at positions outer of the light incidence-side concave portion 19c in the radial direction. The attachment shaft portions 19d protrude toward the LED board 18 and serve as attachment structure of the diffuser lens 19 to the LED board 18. The attachment shaft portions 19d are located closer to an outer edge than the light incidence-side concave portion 19c in the diffuser lens 19, and a line connecting the attachment portions is substantially equilateral-triangular in a plan view. By fixing each of front ends of the attachment shaft portions 19d to the LED board 18 with an adhesive or the like, the diffuser lens 19 can be fixedly attached to the LED board 18. The diffuser lens 19 is fixed to the LED board 18 through the attachment shaft portions 19d so as to have a predetermined gap between the light incidence surface 19a and the LED board 18. This gap allows incidence of light from space outer of the diffuser lens 19 in a plan view. In the above-mentioned attachment state, a front end of the LED 17 protruding from the LED board 18 enters into the light incidence-side concave portion 19c.

The light emitting surface 19b in the diffuser lens 19 is shaped like a substantially flat spherical surface. Thereby, the diffuser lens 19 can emit light while refracting the light on an interface with an external air layer in a direction away from the center, that is, with a wide angle. The light emitting surface 19b has a light-emitting side concave portion 19e. The light-emitting side concave portion 19e is formed in an area where the light emitting surface 19b overlaps with the LED 17 in a plan view. The light-emitting side concave portion 19e is substantially bowl-like and is shaped like a substantially flat sphere having a circumferential surface inclined downward toward the center.

An angle that a tangent line to the circumferential surface of the light-emitting side concave portion 19e forms with the optical axis LA of the LED 17 is set to be larger than an angle that the inclined surface of the light incidence-side concave portion 19c forms with the optical axis LA. The area where the light emitting surface 19b overlaps with the LED 17 in a plan view receives extremely larger light amount from the LED 17 than the other area and therefore, its brightness tends to locally become high. However, by forming the light-emitting side concave portion 19e in the area, it becomes possible to emit most of the light from the LED 17 while refracting the light with a wide angle, or reflect a part of the light from the LED 17 toward the LED board 18. Thereby, it is possible to prevent the brightness of the area where the light emitting surface 19b overlaps with the LED 17 from locally becoming high, which is preferable for prevention of uneven brightness.

Next, the reflection sheet 21 will be described. The reflection sheet 21 consists of a first reflection sheet 22 that covers the entire inner surface of the chassis 14, that is, crosses over all of the LED boards 18 and a second reflection sheet 23 that independently covers each LED board 18. The second reflection sheet 23 is placed on the front side of the LED board 18, while the first reflection sheet 22 is placed on the front side of the second reflection sheet 23. In other words, the second reflection sheet 23 and the first reflection sheet 22 of the reflection sheet 21 are laminated on the front side surface of the LED board 18 in this order, and the second reflection sheet 23 is interposed between the LED board 18 and the first reflection sheet 22. The reflection sheets 22 and 23 each are made of synthetic resin, have a surface of white color having a high light reflectance and extend in the chassis 14 along the bottom plate 14a (LED board 18).

First, the first reflection sheet 22 will be described. As shown in FIG. 3, most part of a central part of the first reflection sheet 22, which extends along the bottom plate 14a of the chassis 14 (opposite to the bottom plate 14), is a body portion 22a. The body portion 22a has almost the same dimension as the bottom plate 14a in a plan view, and can cover the board arrangement areas BA and the board non-arrangement areas NBA of the bottom plate 14a together. That is, the body portion 22a is sufficiently larger than each LED board 18 in a plan view. In the body portion 22a, an overlapping part with each LED board 18 (each board positioning portion 27 and each board arrangement area BA) in a plan view is defined as a board overlapping part BL and a non-overlapping part with each LED board 18 in a plan view is defined as a board non-overlapping part NBL. The board overlapping part BL has the same planar arrangement (planar shape) as each board arrangement area BA in the bottom plate 14a of the chassis 14 and the board non-overlapping part NBL has the same planar arrangement (planar shape) as each board non-arrangement area NBA in the bottom plate 14a, and thus, overlapping description thereof is omitted.

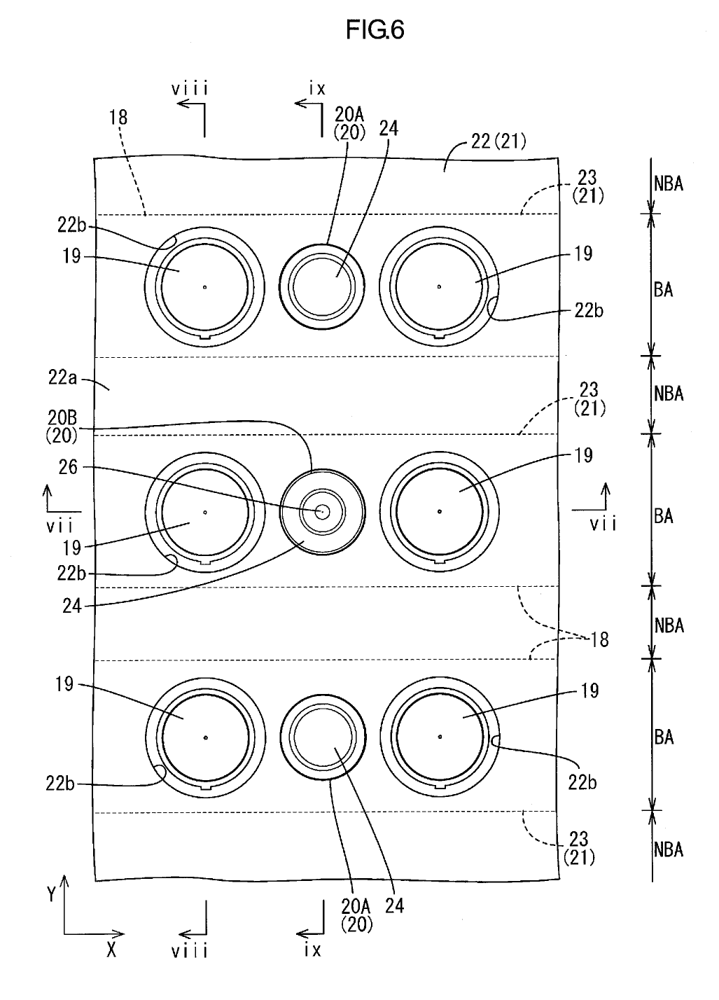

The body portion 22a includes a penetrating (opened) lens insertion hole 22b configured to pass each LED 17 and the diffuser lens 19 covering each LED 17 therethrough. The plurality of lens insertion holes 22b is arranged in parallel at positions where the lens insertion holes 22b overlap with the LEDs 17 and diffuser lenses 19 on the body portion 22a in a plan view in a matrix. As shown in FIG. 6, each lens insertion hole 22b is circular in a plan view and has a larger diameter than the diffuser lens 19. Thereby, when the first reflection sheet 22 is installed in the chassis 14, the diffuser lenses 19 can surely be inserted into the respective lens insertion holes 22b irrespective of presence or absence of dimension error. As shown in FIG. 3, the first reflection sheet 22 covers an outer circumferential area and areas between the adjacent diffuser lenses 19 in the chassis 14 and thus, can reflect light to the areas toward the optical member. The body portion 22a includes a hole that passes a connector part 18a therethrough formed at an overlapping position with the connector part 18a in a plan view. Further, as shown in FIGS. 4 and 5, outer circumferential portions of the first reflection sheet 22 rise so as to cover the side plates 14c and the receiving plates 14d of the chassis 14, and portions placed on the receiving plates 14d are sandwiched between the chassis 14 and the optical member 15. The first reflection sheet 22 has an inclined portion that connects the body portion 22a with each of the portions placed on the receiving plates 14d.

Meanwhile, the second reflection sheet 23 has, as shown in FIG. 11, almost the same appearance as the LED board 18, that is, is rectangular in a plan view. As shown in FIGS. 7 and 8, the second reflection sheet 23 is arranged so as to overlap with the front side surface of the LED board 18, and is opposite to the diffuser lens 19. That is, the second reflection sheet 23 is interposed between the diffuser lens 19 and the LED board 18. Accordingly, light returned from the diffuser lens 19 to the LED board 18 and light entering from space outer of the diffuser lens 19 in a plan view into space between the diffuser lens 19 and the LED board 18 can be reflected toward the diffuser lens 19 by the second reflection sheet 23 again. As a result, light utilization efficiency can be enhanced, thereby increasing brightness. In other words, even when the number of installed LEDs 17 is reduced to cut costs, sufficient brightness can be obtained.

As shown in FIG. 11, the second reflection sheet 23 has almost the same long-side dimension and short-side dimension as the LED board 18 (board positioning portion 27). That is, the second reflection sheet 23 has almost the same dimension as the LED board 18 in a plan view. Accordingly, the second reflection sheet 23 together with the LED board 18 can be stored in the board storing space BS of the board positioning portion 27 in the chassis 14. As shown in FIGS. 6 and 8, the short-side dimension of the second reflection sheet 23 is set to be larger than the diameter of the diffuser lens 19 and the lens insertion hole 22b of the first reflection sheet 22. Accordingly, almost the entirety of the edge of the lens insertion hole 22b of the first reflection sheet 22 can be placed on the front side of the second reflection sheet 23. Thereby, since the first reflection sheet 22 and the second reflection sheet 23 are continuously arranged in the chassis 14 in a plan view, the chassis 14 or the LED board 18 is not exposed from the lens insertion hole 22b to the front side. Therefore, light in the chassis 14 can be efficiently reflected toward the optical member 15, which is extremely preferable for improvement of brightness. The second reflection sheet 23 includes LED insertion holes 23a that pass the respective LEDs 17 therethrough and shaft portion insertion holes 23b that pass the respective attachment shaft portions 19d of the diffuser lens 19 therethrough at overlapping positions in a plan view.

Subsequently, the holding member 20 will be described below. The holding member 20 is classified into two types: a multifunctional holding member 20B having both of the function of holding the LED board 18 (each of the reflection sheets 22 and 23) and the function of supporting the optical member 15 and a monofunctional holding member 20A having the holding function and no supporting function. Hereinafter, when the holding member 20 needs to be distinguished, a subscript A is added to the reference numeral of the monofunctional holding member, a subscript B is added to the reference numeral of the multifunctional holding member and no subscript is added to the holding member that is not distinguished and is collectively called.

First, arrangement of the holding members 20 in the chassis 14 will be described. As shown in FIG. 3, multiple holding members 20 are arranged in parallel in the bottom plate 14a of the chassis 14. Describing in detail, the plurality of holding members 20 is arranged in the X-axis direction (the long-side direction of the chassis 14 and the LED board 18) as the row direction and in the Y-axis direction (the short-side direction of the chassis 14 and the LED board 18) in the bottom plate 14a (arranged in a matrix). Each holding member 20 is located at an overlapping position with each LED board 18 in a plan view and between the adjacent diffuser lenses 19 (LEDs 17). Accordingly, each holding member 20 is arranged like the diffuser lens 19 and the LED 17. Since one holding member 20 is arranged between the adjacent diffuser lenses 19 (LEDs 17) on the LED board 18, the diffuser lens 19 (LED 17) and the holding member 20 are alternately arranged substantially in the X-axis direction. Specifically, four holding members 20 are attached to each LED board 18. In the six-mounted type LED board 18, the holding members 20 are arranged at positions other than the center in the long-side direction in the areas between adjacent diffuser lenses 19 (LEDs 17), and in the five-mounted type LED board 18, the holding members 20 are arranged in all of areas between the adjacent diffuser lenses 19 (LED 17).

As shown in FIG. 3, all of the multiple holding members 20 arranged as described above are the monofunctional holding members 20A except for below-mentioned two multifunctional holding members 20B. The two multifunctional holding members 20B are arranged at the center of the chassis 14 in the short-side direction and at the position closer to the center than an outer end in the long-side direction, respectively. Describing the arrangement in the long-side direction in detail, the multifunctional holding members 20B are located so as to be symmetrical about the central LED board 18 among the three LED boards 18 arranged in parallel in the X-axis direction.

Subsequently, specific configuration of the holding member 20 will be described. Although the holding member 20 is classified into two types as described above, most of the configuration is common and the common configuration will first be described. The holding member 20 is made of synthetic resin such as polycarbonate and has a surface of white color having a high light reflectance. The holding member 20 is substantially circular as a whole in a plan view. As shown in FIGS. 7 and 9, the holding member 20 includes a body portion 24 along the bottom plate 14a of the chassis 14 and the plate surface of the LED board 18 and a fixed portion 25 that protrudes from the body portion 24 toward the back side, that is, the chassis 14 and is fixed to the chassis 14. The holding member 20 is shaped to be symmetrical about the center axis along the Z-axis direction as a whole.

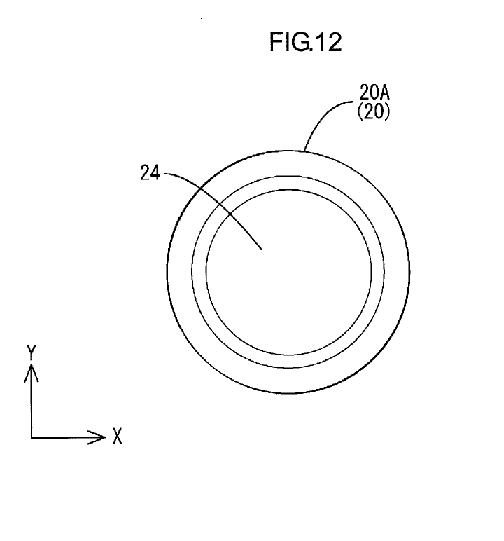

As shown in FIGS. 12 to 15, the body portion 24 is substantially circular in a plan view, and is shaped like a plate extending substantially straight in the X-axis direction and the Y-axis direction. As shown in FIG. 6, the diameter of the body portion 24 is set to be smaller than the short-side dimension of the LED board 18 (dimension in the Y-axis direction). The body portion 24 is attached at an overlapping position with the LED board 18 in a plan view, thereby holding the LED board 18 between the body portion 24 and the bottom plate 14a of the chassis 14. Since the body portion 24 is attached in the state where the reflection sheets 22 and 23 are previously arranged on the front side of the LED board 18, the body portion 24 can sandwich the LED board 18 and the reflection sheets 22 and 23 together (FIGS. 7 and 9). That is, the holding member 20 according to this embodiment can sandwich (hold) the reflection sheets 22 and 23 and the LED board 18, which are laminated, between the holding member 24 and the chassis 14.

Describing in detail, as shown in FIG. 6, the body portion 24 is located so that its center corresponds to the center of the LED board 18 in the short-side direction. Accordingly, the body portion 24 can sandwich the central part of the LED board 18 in the short-side direction over a predetermined width between the body portion 24 and the chassis 14. The body portion 24 entirely overlaps with the LED board 18 in a plan view and is prevented from extending to the outside of the LED board 18. The diameter of the body portion 24 is set to be smaller than the interval (arrangement pitch) between the adjacent diffuser lenses 19 (LEDs 17) in the X-axis direction. Thereby, the body portion 24 is arranged in the area between the adjacent diffuser lenses 19 (LEDs 17) of the LED board 18 in the X-axis direction, that is, the unluminous part of the LED board 18, and does not overlap with the LED 17 in a plan view. That is, it can be prevented that the body portion 24 blocks light emission from the LED 17. In this embodiment, since the interval between LEDs 17 is made sufficiently large by using the diffuser lens 19 as described above, the holding member 20 is arranged in the space and fixes the LED board 18.

As shown in FIG. 9, the fixed portion 25 is configured to engage with the bottom plate 14a through the attachment hole 14e formed at the position corresponding to the attachment position of the holding member 20 on the bottom plate 14a of the chassis 14. The body portion 24 including the fixed portion 25 is arranged so as to entirely overlap with the LED board 18 in a plan view as described above (FIG. 6). Accordingly, the fixed portion 25 similarly overlaps with the LED board 18 in a plan view and thus, the LED board 18 includes a through hole 18b that passes the fixed portion 25 therethrough. As shown in FIG. 10, the through hole 18b is arranged between the adjacent LEDs 17 (diffuser lenses 19) on the LED board 18, that is, at the non-overlapping position with the LED 17 (diffuser lens 19) in a plan view. As shown in FIG. 7, FIG. 9 and FIG. 11, through holes 22c and 23c configured to communicate with the through hole 18b of the LED board 18 and pass the fixed portion 25 therethrough are formed at the overlapping position with the through hole 18b of the LED board 18 in a plan view in the reflection sheets 22 and 23 sandwiched between the body portion 24 and the LED board 18, respectively. The attachment hole 14e into and with which the fixed portion 25 is inserted and engaged is formed at the overlapping position with the through holes 18b, 22c and 23c in a plan view in the bottom plate 14a of the chassis 14. As shown in FIGS. 7 and 9, the attachment hole 14e is arranged at the bottom wall part 27c of the board positioning portion 27 in the bottom plate 14a. In the bottom plate 14a of the chassis 14 and the body portion 22a of the first reflection sheet 22, the plurality of attachment holes 14e and through holes 22c corresponding to the attachment positions of the holding members 20 are arranged in parallel in the X-axis direction and the Y-axis direction in a matrix (FIG. 16).

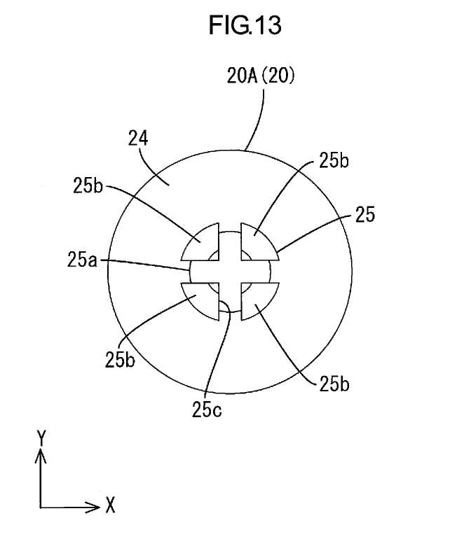

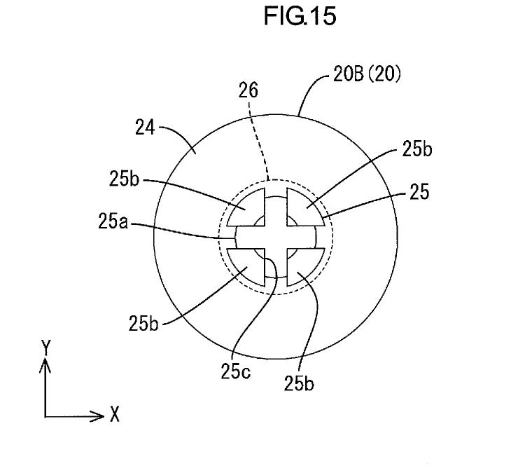

As shown in FIGS. 13 and 15, the fixed portion 25 is located at the center of the body portion 24. Describing in detail, the fixed portion 25 is located so as to be substantially concentric with the body portion 24. As shown in FIG. 9, the fixed portion 25 protrudes from the back side surface of the body portion 24 (the surface opposite to the chassis 14) toward the back side and has an elastic engaging piece 25b obtained by forming a grooved part 25c at a front end thereof. In other words, the fixed portion 25 consists of a bottom part 25a protruding from the body portion 24 toward the back side and the elastic engaging piece 25b further protruding from a protruding front end of the bottom part 25a toward the back side. The bottom part 25a is substantially cylindrical and has the diameter that is smaller than that of the attachment hole 14e of the chassis 14 and allows insertion into the through holes 18b, 22c and 23c and the attachment hole 14e.

As shown in FIGS. 13 and 15, the elastic engaging piece 25b is divided into four by forming the grooved part 25c to be a cross in a plan view. As shown in FIGS. 7 and 9, each elastic engaging piece 25b is cantilevered and can be elastically deformed so as to be recessed in the grooved part 25c using a protruding bottom end of the bottom part 25a as a fulcrum. That is, the grooved part 25c is a bending space of each elastic engaging piece 25b. The elastic engaging piece 25b has an engaging part 25d that expands outward, that is, to the side opposite to the grooved part 25c at an outer side surface thereof. The engaging part 25d protrudes further than an outer circumferential surface of the bottom part 25a, and the diameter at the expanding end of the fixed portion 25 (largest diameter) is set to be larger than the diameter of each of the through holes 18b, 22c and 23c and the attachment hole 14e. In other words, the expanding end of the engaging part 25d is located outer than an inner circumferential surface of the attachment hole 14e. Accordingly, the engaging part 25d is engaged with the edge of the attachment hole 14e in the chassis 14, that is, the part adjacent to the fixed portion 25 in the chassis 14 from the back side. When the fixed portion 25 is inserted into the attachment hole 14e of the chassis 14 in this manner, each elastic engaging piece 25b is inserted into the attachment hole 14e and then, is elastically engaged with the edge of the attachment hole 14e from the backside. Thereby, the holding member 20 can be fixedly attached to the chassis 14.

Next, difference between the two types of holding members 20 in configuration will be described. As shown in FIG. 9, in the monofunctional holding member 20A, the outer circumferential end surface of the body portion 24 includes an inclined surface 24 thereon. The inclined surface 24a is inclined downward from the center to the outer end of the body portion 24, thereby eliminating or reducing the step that can be generated between the body portion 24 and the first reflection sheet 22. As a result, the outer edge of the body portion 24 (boundary between body portion 24 and the reflection sheet 21) is hard to be visually recognized as uneven brightness through the optical member 15. Although not shown, the inclined surface 24a may be provided at the multifunctional holding member 20B.

As shown in FIGS. 7 and 9, the multifunctional holding member 20B has an optical member supporting portion 26 that protrudes from the body portion 24 toward the front side and is configured to support the optical member 15 from the back side. The optical member supporting portion 26 is conical as a whole. Describing in detail, the optical member supporting portion 26 has a circular cross section taken along the plate surface of the body portion 24, and is tapered so that the diameter gradually reduces from its protruding bottom end to its protruding front end. The optical member supporting portion 26 is configured to contact with a diffuser plate 15a arranged closest to the back side (the side of the LED 17) in the optical member 15, thereby supporting the diffuser plate 15a at a predetermined position. That is, the optical member supporting portion 26 can restrict positional relationship between the optical member 15 and the LED 17 in the Z-axis direction (direction perpendicular to the surface of the optical member 15) to a certain state.

The outer diameter of the optical member supporting portion 26 at the protruding bottom end is smaller than both the short-side dimension of the body portion 24 and the short-side dimension of the LED board 18. That is, the optical member supporting portion 26 is a point in a plan view, while the body portion 24 is a plane that is larger than the optical member supporting portion 26 in a plan view. The protruding dimension of the optical member supporting portion 26 is almost equal to the distance between the front side surface of the body portion 24 and the back side surface of the diffuser plate 15a extending substantially straight in the X-axis direction and the Y-axis direction. Accordingly, the optical member supporting portion 26 is configured to contact with the substantially straight diffuser plate 15a. The protruding front end of the optical member supporting portion 26 as a contact part with the diffuser plate 15a is rounded. Since only the optical member supporting portion 26 protrudes from the body portion 24 toward the front side in the multifunctional holding member 20B, in attaching the multifunctional holding member 20B to the chassis 14, the operator can use the optical member supporting portion 26 as the operating part. Thereby, workability in attaching or detaching the multifunctional holding member 20B can be improved.

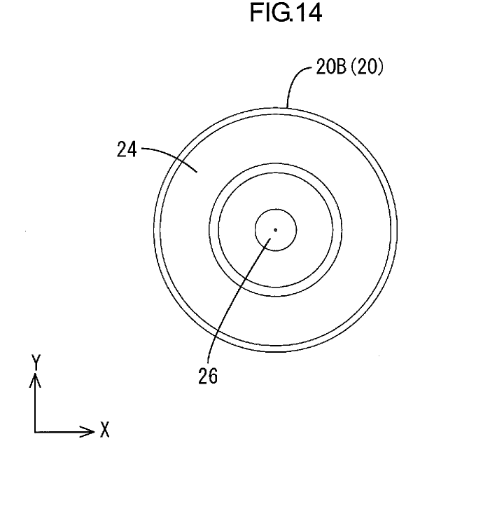

As shown in FIGS. 14 and 15, the optical member supporting portion 26 is arranged substantially at the center of the body portion 24. That is, the optical member supporting portion 26 is arranged so as to overlap with the fixed portion 25 arranged on the back side in a plan view. Describing in more detail, the optical member supporting portion 26 and the fixed portion 25 are arranged so as to be substantially concentric with each other in a plan view. With this configuration, in attaching the multifunctional holding member 20B to the chassis 14, when the operator uses the optical member supporting portion 26 as the operating part, the operator can easily grasp the position of the fixed portion 25 hidden on the back side by viewing the optical member supporting portion 26 exposed on the front side. Accordingly, workability in inserting the fixed portion 25 into the attachment hole 14e can be improved.

As described above, as shown in FIG. 8, FIG. 9 and FIG. 17, the board positioning portion 27 positioning the LED board 18 is provided at the chassis 14 according to this embodiment, and the board positioning portion 27 is formed by partially protruding the bottom plate 14a of the chassis 14 toward the back side (side opposite to the opening 14b). The LED board 18 stored in the board positioning portion 27 is supported by the bottom wall part 27c constituting the board positioning portion 27 from the back side, which constitutes a first supporting portion 28 supporting the LED board 18. The board overlapping part BL of the first reflection sheet 22 is placed on the LED board 18 supported by the first supporting portion 28 through the second reflection sheet 23, and the board overlapping part BL is supported by the front side surface (counter surface facing the first reflection sheet 22) of the second reflection sheet 23 from the back side. Meanwhile, in the bottom plate 14a of the chassis 14, the area where no board positioning portion 27 is provided, that is, the board non-arrangement area NBA where no LED board 18 is arranged, is located at the position further protruded (raised) toward the front side than the first supporting portion 28, and the board non-overlapping part NBL of the first reflection sheet 22 can be supported from the back side, which constitutes a second supporting portion 29 supporting the board non-overlapping part NBL of the first reflection sheet 22. That is, in the chassis 14 according to this embodiment, in the first reflection sheet 22, the second reflection sheet 23 and the LED board 18, on which the board overlapping part BL is placed, are supported by the first supporting portion 28 arranged on the back side, and the board non-overlapping part NBL is supported by the second supporting portion 29 arranged on the front side, so that the support positions of the board overlapping part BL and the board non-overlapping part NBL in the first reflection sheet 22 in the Z-axis direction (direction perpendicular to the bottom plate 14e and the plate surface of the body portion 22a) match each other, eliminating a step.

Describing in detail, in the board positioning portion 27 having the first supporting portion 28, the protruding dimension from the board non-overlapping part NBL (second supporting portion 29) of the bottom plate 14a to the back side is approximately equal to a sum of thicknesses of the LED board 18 and the second reflection sheet 23. Accordingly, when the LED board 18 is stored in the board storing space BS of the board positioning portion 27, the front side surface of the LED board 18 is recessed toward the back side further than the front side surface of the second supporting portion 29, and the front side surface of the second reflection sheet 22 placed on the front side of the LED board 18 is substantially in flush with the front side surface of the second supporting portion 29. That is, since the first supporting portion 28 is recessed toward the back side further than the second supporting portion 29 by the thicknesses of the LED board 18 and the second reflection sheet 23, the second reflection sheet 23 is substantially in flush with the counter surface (supporting surface) of the second supporting portion 29 facing the first reflection sheet 22. In other words, the support positions of the board overlapping part BL and the board non-overlapping part NBL in the first reflection sheet 22 on the side of the chassis in the Z-axis direction are almost equal to each other, eliminating a step substantially completely.

Describing in more detail, as shown in FIG. 16, the second supporting portion 29 (board non-arrangement area NBA) is formed in a lattice in a plan view so as to surround each of the board positioning portions 27 (LED boards 18) arranged in parallel in a matrix in the bottom plate 14a of the chassis 14. In other words, the second supporting portion 29 is shaped like an endless ring so as to surround the entire circumference of each board positioning portion 27. Accordingly, a pair of second supporting portions 29 is arranged so as to sandwich between the board positioning portion 27 in the X-axis direction (long-side direction) and the Y-axis direction (short-side direction) in a plan view and further, is interposed between the adjacent board positioning portions 27 in a plan view. As shown in FIG. 8, FIG. 9 and FIG. 17, the second supporting portion 29 is arranged over the entire circumference (including the area between the adjacent board positioning portions 27) of each board positioning portion 27, is shaped like a flat plate extending in the X-axis direction and the Y-axis direction, and is configured to be in surface-contact with the board non-overlapping part NBL of the first reflection sheet 22 placed on the front side. That is, the board non-overlapping part NBL of the first reflection sheet 22 is wholly supported by the second supporting portion 29. Accordingly, the second supporting portion 29 and each second reflection sheet 23 placed on each LED board 18 have no gap at the boundary (gap in the X-axis direction and the Y-axis direction) so that their counter surfaces facing the first reflection sheet 22 constitute one continuous plane without step and break. Thereby, the body portion 22a of the first reflection sheet 22 is supported by each second reflection sheet 23 having the board overlapping part BL wholly placed on the LED board 18, and the entire board non-overlapping part NBL is supported by the second supporting portion 29 in the surface contact state, resulting in that flatness as a whole can be ensured. In other words, a gap between the body portion 22a of the first reflection sheet 22 and the bottom plate 14a of the chassis 14 in the Z-axis direction is hardly generated.

This embodiment has the above-mentioned configuration, and its action will be described. The liquid crystal display device 10 shown in FIGS. 4 and 5 is manufactured by separately manufacturing the liquid crystal panel 11 and the backlight unit 12 and assembling them by use of the bezel 13 or the like. Especially, the assembling operation in manufacturing the backlight unit 12 will be described in detail.

In this embodiment, prior to assembling of each component to the chassis 14, LEDs 17, the second reflection sheet 23 and the diffuser lenses 19 are attached to the LED board 18. Describing in detail, first, as shown in FIG. 10, after the LEDs 17 are mounted at predetermined positions on the LED board 18, the second reflection sheet 23 is attached to cover the front side. At this time, each LED 17 is inserted into each LED insertion hole 23a of the second reflection sheet 23, and the LED board 18 and the through holes 18b and 23c of the second reflection sheet 23 are matched and communicated with one another. After that, as shown in FIG. 11, the diffuser lenses 19 are attached to the LED board 18 so as to cover the respective LEDs 17. At this time, the attachment shaft portions 19d of the diffuser lenses 19 are fixedly adhered to the LED board 18 with an adhesive through the respective shaft portion insertion holes 23b in the second reflection sheet 23. In this manner, a so-called light source unit U formed by uniting the LEDs 17, the second reflection sheet 23 and the diffuser lenses 19 is manufactured on the LED board 18.

Subsequently, an assembling operation of each component to the chassis 14 will be described. First, the light source units U are stored from the front side of the chassis 14 through the openings 14b and are arranged at predetermined attachment positions on the bottom plate 14a. In arranging the LED board 18, the LED board 18 and the second reflection sheet 23 are stored in the board storing space BS of each board positioning portion 27 provided at the arrangement position (board arrangement area BA) of the bottom plate 14a. Then, since the entire outer edge of the LED board 18 and the second reflection sheet 23 are fitted (contacted) to each of the side wall parts 27a and 27b of the board positioning portion 27, the LED board 18 and the second reflection sheet 23 are correctly positioned with respect to the chassis 14 in the X-axis direction and the Y-axis direction in a two-dimensional way (FIG. 8, FIG. 9 and FIG. 17). At this time, the front side surface of the second reflection sheet 23 is substantially in flush with the front side surface of the second supporting portion 29 as the board non-arrangement area NBA in the bottom plate 14a. The front side surfaces of the second reflection sheet 23 and the second supporting portion 29, that is, the counter surfaces facing the first reflection sheet 22, are connected to each other without any break in the X-axis direction and the Y-axis direction and the step in the Z-axis direction is eliminated substantially completely, which constitutes one almost straight and flat plane extending in the X-axis direction and the Y-axis direction (the plate surface of the body portion 22a of the first reflection sheet 22). By engaging the adjacent connector parts 18a with each other, the adjacent LED boards 18 can be electrically connected to each other in the X-axis direction. The operation of connecting the LED boards 18 aligned in the X-axis direction to each other is not necessarily performed within the chassis 14, and may be performed outside of the chassis 14.

When arrangement of all of the light source units U is completed, an operation of arranging the first reflection sheet 22 in the chassis 14 is performed. At this time, each diffuser lens 19 is inserted into each lens insertion hole 22b while positioning each lens insertion hole 22b of the first reflection sheet 22 with respect to each diffuser lens 19 in the light source unit U (FIG. 3). When the first reflection sheet 22 is attached, the body portion 22a is placed on the front side of the bottom plate 14a to which each light source unit U is attached over the entire area. At this time, each board overlapping part BL of the body portion 22a is placed on almost all of areas other than the overlapping area of each second reflection sheet 23 stored in each board positioning portion 27 with the diffuser lens 19 in a plan view on the front side, and the board non-overlapping part NBL is placed on the front side of the second supporting portion 29 as the board non-arrangement area NBA in the bottom plate 14a (FIG. 8, FIG. 9 and FIG. 17). Here, since each second reflection sheet 23 and the counter surface of the second supporting portion 29, which receive the body portion 22a of the first reflection sheet 22, cooperate to constitute a flat plane without almost no irregularity (step and gap), when the body portion 22a is placed thereon, the body portion 22a is supported while keeping high flatness. Accordingly, stress concentration on the boundary between the board overlapping part BL and the board non-overlapping part NBL in the body portion 22a hardly occurs and therefore, deformation (irregularity) of the body portion 22a can be effectively suppressed. At this time, the entire edge of the lens insertion hole 22b in the first reflection sheet 22 is placed on the front side of the second reflection sheet 23. The through hole 22c of the first reflection sheet 22 are matched and communicated with the through holes 18b and 23c of the LED board 18 and the second reflection sheet 23 and the attachment hole 14e of the chassis 14. After that, the operation of assembling the holding member 20 is performed.

In assembling each holding member 20 above, the holding member 20 is inserted into the chassis 14 from the front side through the opening 14b and is stored in the chassis 14, and the fixed portion 25 is inserted into the through holes 18b, 22c and 23c and the attachment hole 14e. During the process of inserting the fixed portion 25, each elastic engaging piece 25b is pushed by the edges of the through holes 18b, 22c and 23c and the attachment hole 14e and is elastically deformed once so as to be recessed into the grooved part 25c. Then, when each elastic engaging piece 25b passes through the attachment hole 14e and the fixed portion 25 is inserted to reach the back side of the chassis 14, as shown in FIGS. 7 and 9, each elastic engaging piece 25b elastically returns and the engaging part 25d is engaged with the edge of the attachment hole 14e from the back side. Thereby, the holding member 20 is prevented from being detached from the chassis 14 and is fixedly attached. In this state, the LED board 18 and the reflection sheets 22 and 23 are sandwiched between the body portion 24 of the holding member 20 and the bottom plate 14a of the chassis 14 and held together.

In assembling the holding member 20 above, the multifunctional holding member 20B of the holding member 20 is configured to use the optical member supporting portion 26 as the operating part. With this configuration, in assembling the multifunctional holding member 20B, the operator can operate the multifunctional holding member 20B while gripping the optical member supporting portion 26. At this time, since the optical member supporting portion 26 and the fixed portion 25 are arranged so as to overlap with each other and are concentric with each other in a plan view, the operator can easily recognize the position of the fixed portion 25. Accordingly, the operation of inserting the fixed portion 25 into the attachment hole 14e can be smoothly performed.

Since the fixed portion 25 passes through the reflection sheets 22 and 23 and the LED board 18, it is prevented that the reflection sheets 22 and 23 and the LED board 18 unintentionally move in the X-axis direction and the Y-axis direction, thereby being positioned in these directions. Further, since fixation can be achieved by passing the fixed portion 25 through the attachment hole 14e formed in the chassis and then, mechanically engaging the fixed portion 25 therewith, as compared to the case of adopting the fixing means such as the adhesive, fixation can be easily performed at low costs and, the holding member 20 can be easily detached at maintenance and disposal.

After that, the optical member 15 is attached to the chassis 14 so as to cover the openings 14b. According to the specific attaching order of the optical member 15, the diffuser 15a, and then, the optical sheets 15b are attached. As shown in FIGS. 4 and 5, the outer edge of the optical member 15 is received by the receiving plate 14d of the chassis 14 and the central part of the optical member 15 is supported by the optical member supporting portion 26 of the multifunctional holding member 20B. Then, when the frame 16 is attached to the chassis 14, the outer circumference of the optical member 15 is pinched between the frame 16 and the receiving plates 14d. Thereby, manufacturing of the backlight unit 12 is completed. In assembling the manufactured backlight unit 12 and the liquid crystal panel 11, the liquid crystal panel 11 is placed on the frame 16 and then, the bezel 13 is covered on the front side, and they are screwed together. Thereby, the liquid crystal panel 11 is pinched between the frame 16 and the bezel 13 and becomes integral with the backlight unit 12, resulting in that manufacturing of the liquid crystal display device 10 is completed.

In using the liquid crystal display device 10 manufactured as described above, each of the LEDs 17 provided in the backlight unit 12 is lit and an image signal is supplied to the liquid crystal panel 11, thereby displacing a predetermined image on a display screen of the liquid crystal panel 11. As shown in FIGS. 7 and 8, light emitted to light each of the LEDs 17 is first incident on the light incidence surface 19a of the diffuser lens 19. At this time, most of the light is incident on an inclined surface of the light incidence-side concave portion 19c of the light incidence surface 19a and thus, into the diffuser lens 19 while being refracted with a wide angle according to the inclined angle. Then, the incident light propagates in the diffuser lens 19 and is emitted from the light emitting surface 19b. However, since the light emitting surface 19b is a substantially flat spherical surface, light is emitted while being further refracted at a boundary with the external air layer with a wider angle. Moreover, since the substantially bowl-like light-emitting side concave portion 19e is formed in an area where the amount of light from the LED 17 is the largest in the light emitting surface 19b, and its circumferential surface is a substantially flat spherical surface, light can be emitted while being refracted at the circumferential surface of the light-emitting side concave portion 19e with a wide angle, or can be reflected toward the LED board 18. Since light returned to the LED board 18 is reflected toward the diffuser lens 19 by the second reflection sheet 23 and is incident on the diffuser lens 19 once, high brightness can be obtained.

Especially in this embodiment, since the first reflection sheet 22 installed in the almost entire chassis 14 hardly causes deformation (irregularity) as described above and is supported while keeping flatness, unevenness of light (reflected light) that is reflected by the first reflection sheet 22 and then, moves toward the diffuser plate 15a(opening 14b) hardly occurs. Accordingly, unevenness of light emitted from the diffuser plate 15a is also hard to occur. Moreover, since the board positioning portion 27 is formed by partially protruding the chassis 14 toward the back side and the LED board 18 is stored there, the distance between the LED board 18 and the diffuser plate 15a, that is, the light path length where light emitted from each LED 17 reaches the diffuser plate 15a, is increased by the depth of the board positioning portion 27. Accordingly, unevenness of light emitted from the diffuser plate 15a is harder to occur.

Since the highly directive light emitted from the LED 17 can be diffused with a wide angle by the diffuser lens 19, in-plane distribution of the light reaching the optical member 15 can be made uniform. In other words, since the area between the adjacent LEDs 17 becomes hard to be visually recognized as the dark place by using the diffuser lens 19, the interval between the LEDs 17 can be increased, thereby reducing the number of installed LEDs 17 while suppressing uneven brightness. Further, since the interval between the adjacent LEDs 17 can be increased by reducing the number of the LEDs 17, the holding member 20 can be arranged in the widened area, and the holding member 20 can fix the LED board 18.

In using the liquid crystal display device 10 as described above, since each of the LEDs 17 in the backlight unit 12 is lit on or off, internal temperature environment changes and thus, each component of the liquid crystal display device 10 may be thermally expanded or thermally contracted. Among the constituents, the first reflection sheet 22 arranged over the entire chassis 14 expands or contracts to a large extent due to thermal expansion or thermal contraction and thus deformation such as warpage may occur in some cases. Here, deformation caused by change in temperature environment tends to occur especially at the place subjected to stress. That is, when stress concentration on a predetermined place of the first reflection sheet 22 occurs, local deformation due to thermal expansion or thermal contraction tends to occur at this place. In this embodiment, since the body portion 22a of the first reflection sheet 22 is wholly kept flat by being supported from the side of the chassis 14 by the second reflection sheet 23 and the second supporting portion 29 that are in flush with each other as described above, it is prevented that stress concentrates on the boundary between the board overlapping part BL and the board non-overlapping part NBL. Accordingly, even when temperature environment changes to some degree, deformation in the first reflection sheet 22 is hard to occur.

As described above, the backlight unit 12 according to this embodiment includes the LED board 18 having the LED 17 as the light source, the chassis 14 that stores the LED board 18 therein and has the opening 14b that emits light from the LED 17, and the reflection sheet 21 as the reflection member that overlaps with the LED board 18 on the opening 14b side in a plan view, is larger than the LED board 18 and reflects light, and the chassis 14 includes the first supporting portion 28 that supports the LED board 18 and the second supporting portion 29 that is arranged closer to the opening 14b than the first supporting portion 28 and supports the first reflection sheet 22 as the reflection sheet 21.

With this configuration, in the first reflection sheet 22 as the reflection sheet 21, the overlapping part with the LED board 18 on the opening 14b side (board overlapping part BL) is supported by the LED board 18, and the non-overlapping part with the LED board 18 (board non-overlapping part NBL) is supported by the second supporting portion 29 arranged closer to the opening 14b than the first supporting portion 28 supporting the LED board 18. Accordingly, it is possible to mitigate stress concentration on the boundary between the overlapping part with the LED board 18 (board overlapping part BL) and the non-overlapping part with the LED board 18 (board non-overlapping part NBL) in the first reflection sheet 22. As a result, deformation in the first reflection sheet 22 is hard to occur.

At least a pair of second supporting portions 29 is arranged so as to sandwich the LED board 18 therebetween in a plan view. With this configuration, since the first reflection sheet 22 is supported at the position of sandwiching the LED board 18 by the second supporting portion 29, deformation in the first reflection sheet 22 can be effectively suppressed.

The plurality of LED boards 18 is arranged at predetermined intervals in parallel, and the second supporting portion 29 is arranged between the adjacent LED board 18. With this configuration, the part of the first reflection sheet 22, which is arranged between the adjacent LED boards 18, can be suitably supported.

The second supporting portion 29 covers the entire area between the adjacent LED boards 18. With this configuration, since the part of the first reflection sheet 22, which is arranged between the adjacent LED boards 18, can be supported, deformation in the first reflection sheet 22 is harder to occur.

The second supporting portion 29 extends along the outer edge of the LED board 18. With this configuration, since stress concentration on the first reflection sheet 22 over the predetermined length along the outer edge of the LED board 18 can be mitigated, deformation in the first reflection sheet 22 can be effectively suppressed.

The LED board 18 is rectangular in a plan view, and the second supporting portion 29 extends in the long-side direction of the LED board 18. With this configuration, since stress concentration on the first reflection sheet 22 can be mitigated over the predetermined length along the outer edge of the LED board 18 in the long-side direction, deformation in the first reflection sheet 22 can be effectively suppressed.

The second supporting portion 29 surrounds the LED board 18. With this configuration, since stress concentration on the first reflection sheet 22 can be mitigated over the entirety along the outer edge of the LED board 18, deformation in the deformation in the first reflection sheet 22 can be effectively suppressed.

The second supporting portion 29 is in flush with the counter surface of the LED board 18 facing the first reflection sheet 22, that is, the front side surface of the second reflection sheet 23. With this configuration, since the counter surface of the LED board 18, which supports the first reflection sheet 22, and the second supporting portion 29 are in flush with each other, the deformation in the first reflection sheet 22 can be effectively suppressed.

The first supporting portion 28 is formed by partially protruding the chassis 14 toward the side opposite to the opening 14b. With this configuration, since the first supporting portion 28 protrudes toward the side opposite to the opening 14b, the distance between the LED board 18 and the opening 14b can be increased. Accordingly, the light path length where light emitted from the LED 17 and reaches the opening 14b can be ensured long and therefore, unevenness of light emitted from the opening 14b is hard to occur.

The chassis 14 includes the board positioning portion 27 configured to position the LED board 18 in the direction along the plate surface. With this configuration, in arranging the LED board 18 in the chassis 14, the LED board 18 can be positioned in the direction along the plate surface with the board positioning portion 27. Accordingly, the LED board 18 can be reliably supported by the first supporting portion 28, and the LED board 18 can be correctly positioned with respect to the second supporting portion 29.

The board positioning portion 27 extends along the edge of the LED board 18. With this configuration, by fitting the board positioning portion 27 along the edge of the LED board 18, the LED board 18 can be positioned easily and properly.

The LED board 18 is rectangular in a plan view, and the board positioning portion 27 extends in the long-side direction of the LED board 18. With this configuration, rectangular LED board 18 can be positioned more easily and properly.

The board positioning portion 27 is configured to position the LED board 18 in two directions that are along the plate surface and are perpendicular to each other. With this configuration, the LED boards 18 can be correctly positioned in a two-dimensional way.

The board positioning portion 27 includes the first supporting portion 28. With this configuration, as compared to the case where the first supporting portion is provided separately from the board positioning portion 27, the configuration of the chassis 14 can be simplified and manufacturing costs can be reduced.

In the board positioning portion 27, the board storing space BS storing the LED board 18 therein and the first supporting portion 28 are formed by partially protruding the chassis 14 toward the side opposite to the opening 14b. With this configuration, since the board positioning portion 27 protrudes toward the side opposite to the opening 14b, the distance between the LED board 18 stored in the board storing space BS and the opening 14b can be increased. Accordingly, the light path length where light emitted from the LED 17 and reaches the opening 14b can be ensured long and therefore, unevenness of light emitted from the opening 14b is hard to occur.

The lens insertion hole 22b and the LED insertion hole 23a that pass the LED 17 therethrough are formed at the overlapping position with the LED 17 in a plan view LED 17 in the reflection sheet 21. With this configuration, it is prevented that light emission from the LED 17 is blocked by the reflection sheet 21.

The diffuser lens 19 diffusing light from the LED 17 is arranged at the overlapping position with the LED 17 in a plan view in the LED board 18 on the opening 14b side. With this configuration, light emitted from the LED 17 can be diffused by the diffuser lens 19 and then, guided to the opening 14b. As a result, unevenness of light emitted from the opening 14b is hard to occur.

The reflection sheet 21 consists of the first reflection sheet 22 that allows the lens insertion hole 22b to pass the diffuser lens 19 therethrough and the second reflection sheet 23 that is interposed between the LED board 18 and the diffuser lens 19, is arranged so as to overlap with the lens insertion hole 22b provided in the first reflection sheet 22 in a plan view (arranged in the lens insertion hole 22b in a plan view) and reflects light toward the diffuser lens 19, and the second supporting portion 29 supports the first reflection sheet 22. With this configuration, even when the first reflection sheet 22 includes the lens insertion hole 22b that is configured to pass the diffuser lens 19 therethrough, light can be reflected toward the diffuser lens 19 by the second reflection sheet 23 located so as to overlap with the lens insertion hole 22b (arranged in the lens insertion hole 22b in a plan view). As a result, light can be efficiently utilized, which is preferable for improvement of brightness. The first reflection sheet 22 is supported by the second supporting portion 29, thereby deformation of the first reflection sheet 22 is inhibited.

The second reflection sheet 23 is placed on the LED board 18 on the opening 14b side, while the first reflection sheet 22 is placed on the second reflection sheet 23 on the opening 14b side, and the second supporting portion 29 is in flush with the counter surface of the second reflection sheet facing the first reflection sheet 22. With this configuration, since the counter surface of the second reflection sheet 23, which supports the first reflection sheet 22, and the second supporting portion 29 are in flush with each other, deformation in the first reflection sheet 22 can be effectively prevented.

The edge of the lens insertion hole 22b of the first reflection sheet 22 and the second reflection sheet 23 are formed so as to overlap with each other in a plan view. With this configuration, the edge of the lens insertion hole 22b of the first reflection sheet 22 and the second reflection sheet 23 are connected to each other in a plan view without any gap. Thus, light can be used more efficiently.

The holding member 20 holding the LED board 18 and the reflection sheet 21 so as to sandwich them between the holding member 20 and the chassis 14 is provided. With this configuration, the holding member 20 can hold the LED board 18 and the reflection sheet 21 together.

The holding member 20 includes the body portion 24 that sandwiches the LED board 18 and the reflection sheet 21 between the body portion 24 and the chassis 14 and the fixed portion 25 that protrudes from the body portion 24 toward the chassis 14 and is fixed to the chassis 14, and the fixed portion 25 is fixed to the chassis 14 passing through the LED board 18 and the reflection sheet 21. With this configuration, the LED board 18 and the reflection sheet 21 can be positioned in the direction along the plate surface by the fixed portion 25 passing through the LED board 18 and the reflection sheet 21.

The fixed portion 25 passes through the LED board 18, the reflection sheet 21 and the chassis 14, and is engaged with the chassis 14 from the side opposite to the LED board 18. With this configuration, since the holding member 20 can be fixed by engaging the fixed portion 25 passing through the LED board 18, the reflection sheet 21 and the chassis 14 with the chassis 14, fixation can be easily achieved at low costs without requiring another fixing means such as an adhesive.

The light source is the LED 17. With this configuration, higher brightness and lower power consumption can be achieved.

Although the first embodiment of the present invention has been described, the present invention is not limited to this embodiment and for example, may include the following modification examples. In each of the following modification examples, the same members as those in the above-mentioned embodiment are given the same reference numerals and illustration and description thereof may be omitted.

### First Modification Example of First Embodiment

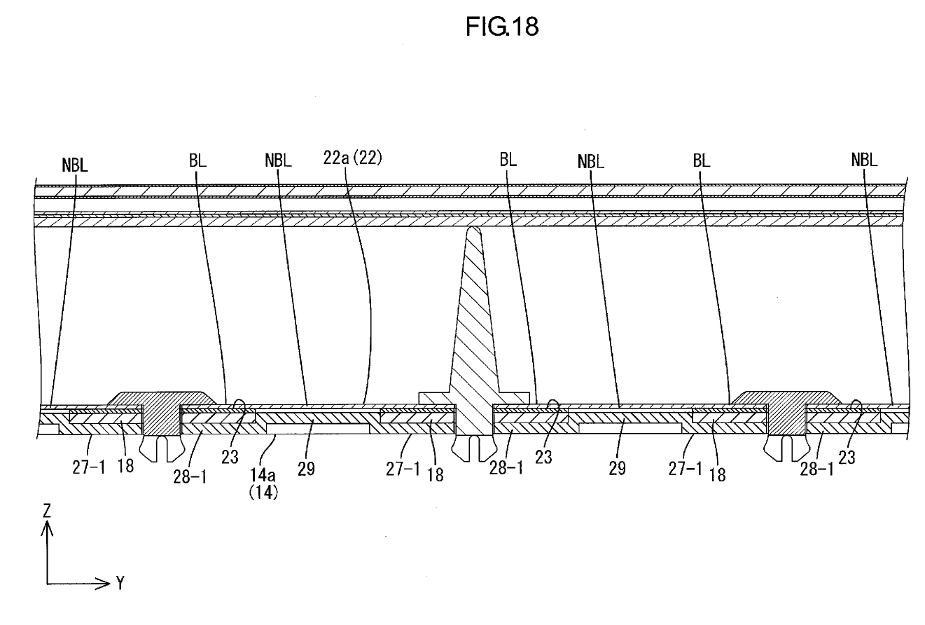

A first modification example of the first embodiment will be described with reference to FIG. 18. Here, positional relationship between a first supporting portion 28-1 and the second supporting portion 29 in the Z-axis direction is modified.

As shown in FIG. 18, the protruding dimension of the board positioning portion 27-1 from the board non-overlapping part NBL of the bottom plate 14a to the back side, that is, the distance between the first supporting portion 28-1 and the second supporting portion 29 in the Z-axis direction is almost equal to the thickness of the LED board 18. Accordingly, in the state where the LED board 18 and the second reflection sheet 23 are stored in the board positioning portion 27-1, the front side surface of the LED board 18 is in flush with the front side surface of the second supporting portion 29, while the front side surface of the second reflection sheet 23 is arranged closer to the front side than the front side surface of the second supporting portion 29. When the first reflection sheet 22 is placed in this state, the board overlapping part BL of the first reflection sheet 22 is supported by the second reflection sheet 23, and a predetermined gap (gap substantially corresponding to the thickness of the second reflection sheet 23) is generated between the board non-overlapping part NBL and the second supporting portion 29. For this reason, stress may concentrate on the boundary between the board overlapping part BL and the board non-overlapping part NBL of the first reflection sheet 22, thereby possibly causing some deformation. However, since the board non-overlapping part NBL can be supported by the second supporting portion 29 arranged closer to the front side than the first supporting portion 28-1 at a certain stage, further deformation can be restricted. Accordingly, local deformation in the first reflection sheet 22 can be suppressed, thereby maintaining flatness to some degree as a whole.

### Second Modification Example of First Embodiment

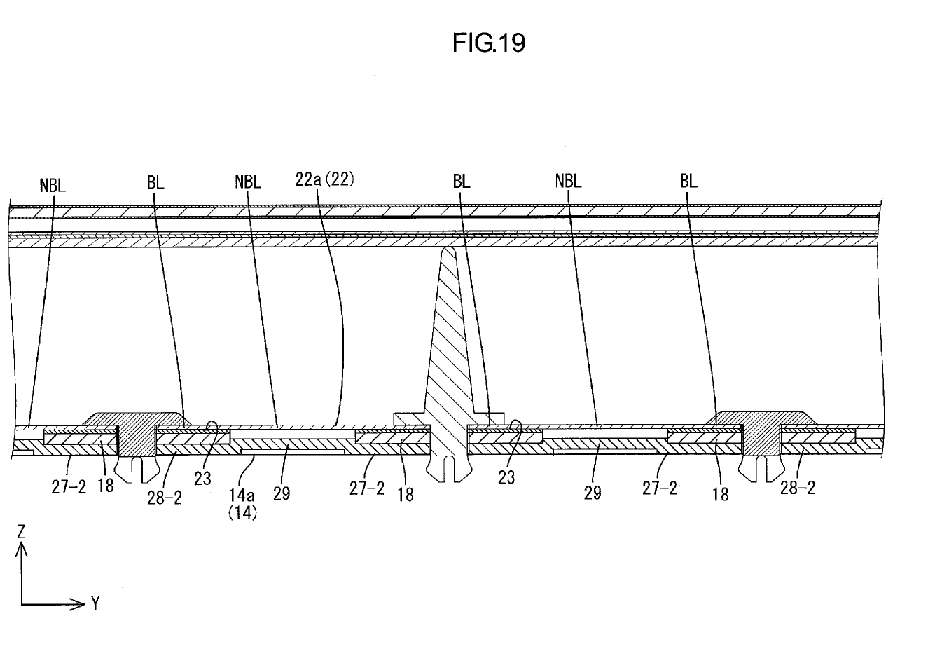

A second modification example of the first embodiment will be described with reference to FIG. 19. Here, positional relationship between a first supporting portion 28-2 and the second supporting portion 29 in the Z-axis direction is modified from that in the first modification example.

As shown in FIG. 19, the protruding dimension of the board positioning portion 27-2 from the board non-overlapping part NBL in the bottom plate 14a to the back side, that is, the distance between the first supporting portion 28-2 and the second supporting portion 29 in the Z-axis direction is set to be smaller than the thickness of the LED board 18. Accordingly, in the state where the LED board 18 and the second reflection sheet 23 are stored in the board positioning portion 27-2, the front side surfaces of the LED board 18 and the second reflection sheet 23 are arranged closer to the front side than the front side surface of the second supporting portion 29. Accordingly, the gap between the board non-overlapping part NBL of the first reflection sheet 22 and the second supporting portion 29 is larger than that in the first modification example and the amount of deformation that can be generated in the first reflection sheet 22 tends to be larger than that in the first modification example. However, even when the first reflection sheet 22 is deformed to some degree, since the deformation is restricted by the second supporting portion 29 at a certain stage, flatness of the first reflection sheet 22 can be maintained to some extent.

### Second Embodiment

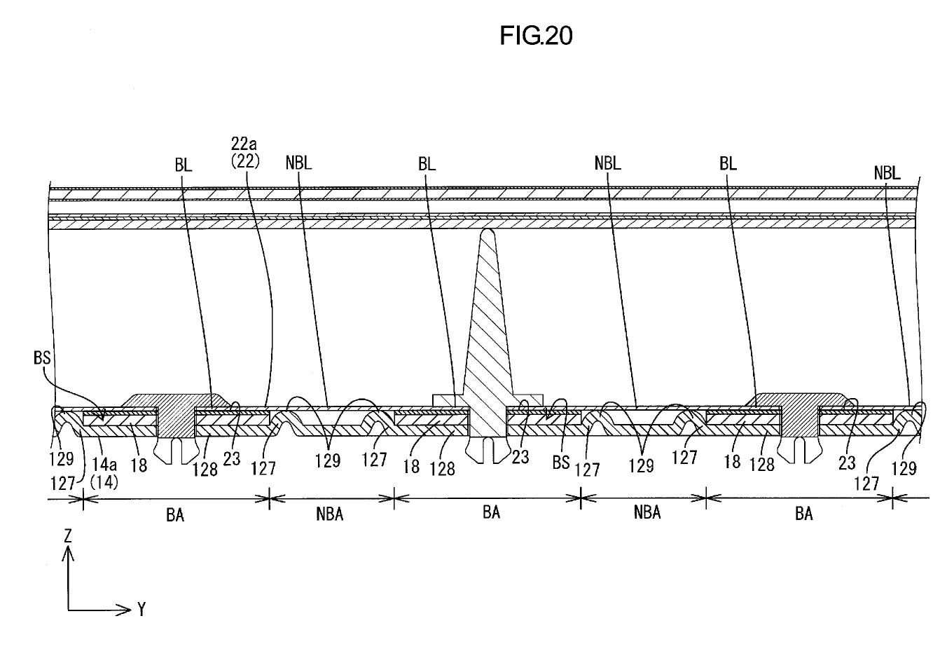

A second embodiment of the present invention will be described with reference to FIG. 20. In the second embodiment, a board positioning portion 127 and a second supporting portion 129 that have modified configuration are shown. Overlapping description of the same configuration, functions and effects as those in the first embodiment is omitted.

As shown in FIG. 20, the board positioning portion 127 is provided in the board non-arrangement area NBA in the bottom plate 14a of the chassis 14. Describing in detail, the board positioning portion 127 is formed by partially protruding the board non-arrangement area NBA of the bottom plate 14a toward the front side, that is, the side of the opening 14b. The board positioning portion 127 is arranged at a part adjacent to each LED board 18 in the board non-arrangement area NBA. The pair of board positioning portions 127 is provided so as to sandwich the LED board 18 in a plan view (between the adjacent LED boards 18), and the interval between the pair of board positioning portions 127 is almost equal to the length of each side of the LED board 18. That is, the board storing space BS configured to store the LED board 18 therein is ensured between the pair of board positioning portions 127. The board positioning portion 127 has an inverted U-like cross section and extends along the outer edge of the LED board 18. The side surface of the board positioning portion 127, which faces the LED board 18, is configured to contact with the LED board 18, thereby positioning the LED board 18 in the direction intersecting the plate surface.

The protruding front end of the board positioning portion 127 serves as the second supporting portion 129 that is configured to support the board non-overlapping part NBL of the first reflection sheet 22 from the back side. That is, the second supporting portion 129 is provided integrally with the board positioning portion 127. The counter surface (support surface) of the second supporting portion 129 facing the first reflection sheet 22 is substantially arcuate, and is in contact with the first reflection sheet 22 in a sectional view and is in linear contact with the first reflection sheet 22 in a plan view. Like the board positioning portion 127, the second supporting portion 129 extends along the outer edge of the LED board 18 and is straight in a plan view. The second supporting portion 129 is partially provided in the board non-arrangement area NBA of the bottom plate 14a. Describing in detail, the pair of second supporting portions 129 is arranged adjacent to each LED board 18. That is, in the board non-arrangement area NBA, the second supporting portion 129 is located closest to the boundary between the board overlapping part BL and the board non-overlapping part NBL (outer end of the LED board 18) of the first reflection sheet 22. Accordingly, by supporting the board non-overlapping part NBL of the first reflection sheet 22 by the second supporting portion 129, stress concentration on the boundary between the board overlapping part BL and the board non-overlapping part NBL is hard to occur, and therefore, deformation can be effectively suppressed. The first supporting portion 128 supporting the LED board 18 from the back side is constituted of the board arrangement area BA of the bottom plate 14a and is arranged closer to the back side than the second supporting portion 129.

As described above, in this embodiment, the second supporting portion 129 is formed by partially protruding the chassis 14 toward the opening 14b. With this configuration, by partially protruding the chassis 14 toward the side opposite to the opening 14b as in the first embodiment, as compared to the case where the first supporting portion 28 is formed (refer to FIG. 9), the second supporting portion 129 can be maintained thin as a whole.

The board positioning portion 127 is formed by partially protruding the chassis 14 toward the opening 14b and includes the second supporting portion 129. With this configuration, as compared to the case where the board positioning portion 27 and the first supporting portion 28 are formed by partially protruding the chassis 14 toward the side opposite to the opening 14b as in the first embodiment (refer to FIG. 9), the board positioning portion 127 can be maintained thin as a whole.

### Third Embodiment

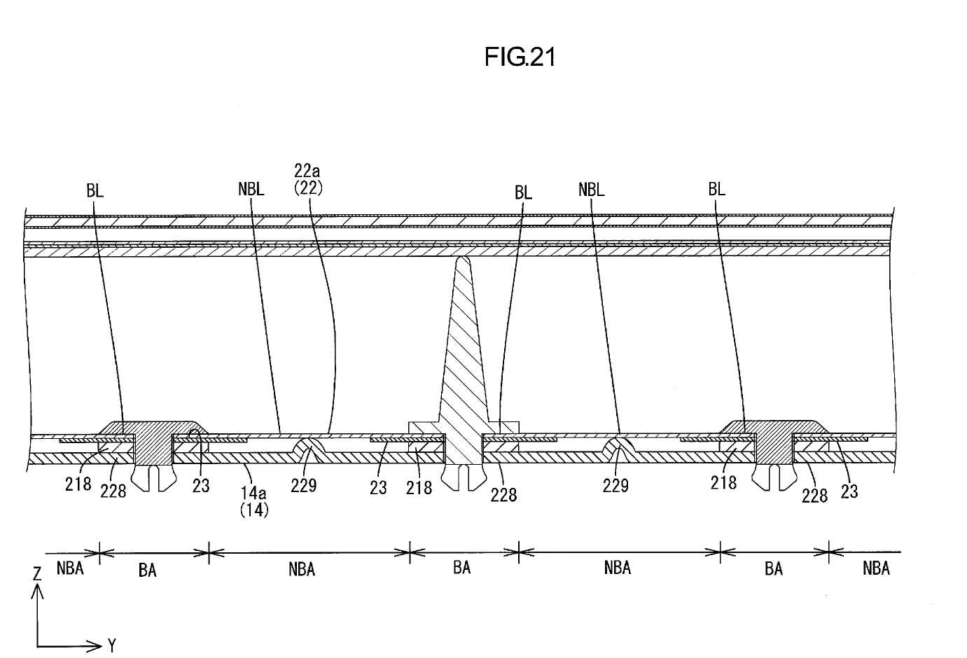

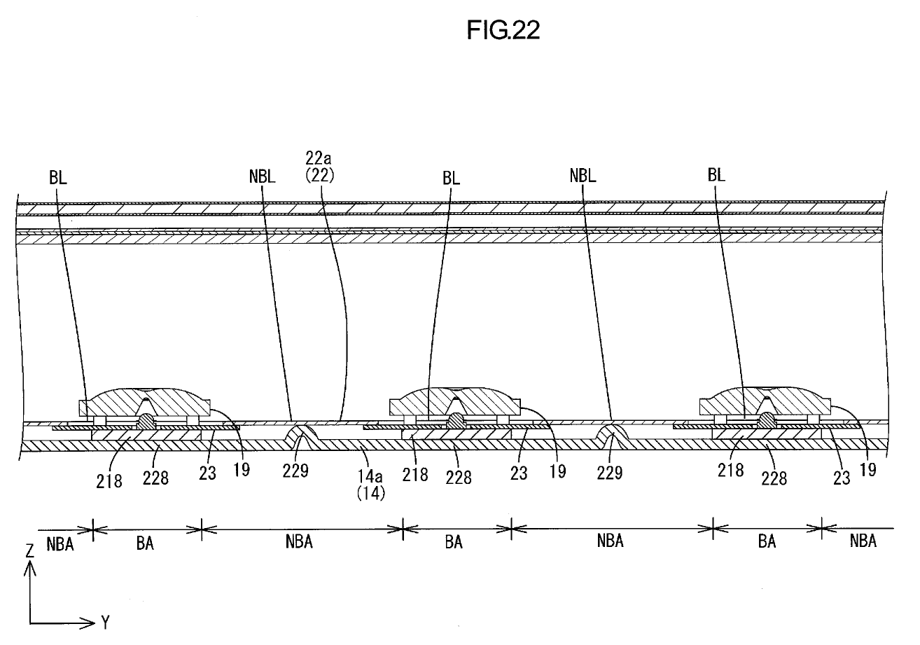

A third embodiment of the present invention will be described with reference to FIG. 21 or 22. In the third embodiment, the board positioning portion is omitted. Overlapping description of the same configuration, functions and effects as those in the first embodiment is omitted.

As shown in FIGS. 21 and 22, on the bottom plate 14a of the chassis 14, no board positioning portion as in each of the above-mentioned embodiments is provided and the second supporting portion 229 is solely provided. The second supporting portion 229 is formed by partially protruding the board non-arrangement area NBA of the bottom plate 14a toward the front side, that is, the side of the opening 14b. Describing in detail, the second supporting portion 229 has an inverted U-like cross section, extends along the outer edge of an LED board 218 and is linear in a plan view. The counter surface (support surface) of the second supporting portion 229 facing the first reflection sheet 22 is substantially arcuate, and is configured to be in point-contact with the first reflection sheet 22 in a sectional view and is in line contact with the first reflection sheet 22 in a plan view. The second supporting portion 229 is arranged substantially at the middle point between the adjacent LED boards 18 in the board non-arrangement area NBA. The pair of second supporting portions 229 is arranged so as to sandwich the LED board 218 therebetween in a plan view, and the distances between the second supporting portions 229 and each LED board 218 are almost equal to each other. That is, the second supporting portion 229 is arranged substantially at the middle position between the boundaries between board overlapping part BL and the board non-overlapping part NBL of the first reflection sheet 22 (outer end of the LED board 218) in the board non-arrangement area NBA. As a result, the board non-overlapping part NBL of the first reflection sheet 22 can be supported in a well-balanced manner and therefore, deformation can be suppressed. As in the second embodiment, a first supporting portion 228 supporting the LED board 18 from the back side consists of the board arrangement area BA of the bottom plate 14a, and is arranged closer to the back side than the second supporting portion 229.

As shown in FIG. 22, the LED board 218 according to this embodiment, dimension in the Y-axis direction is set to be smaller than the second reflection sheet 23 and the diffuser lens 19 and has minimum necessary dimension for supporting the diffuser lens 19. Thereby, material costs of the LED board 218 can be reduced, which is preferable to cost reduction. For the second reflection sheet 23 interposed between the LED board 218 and the diffuser lens 19, by setting dimension in the Y-axis direction to be larger than the LED board 218 and the diffuser lens 19, light reflected by the diffuser lens 19 can be efficiently returned to the diffuser lens 19 and therefore, light use efficiency can be kept high.

As described above, in this embodiment, the second supporting portion 229 is arranged at about the midpoint position of the adjacent LED boards 218. With this configuration, the part arranged between the adjacent LED boards 218 of the first reflection sheet 22 (board non-overlapping part NBL) can be properly supported in a well-balanced manner by one second supporting portion 229.

The third embodiment of the present invention has been described and however, the present invention is not limited to the embodiment and may include following modification examples. Similar members in the following modification example to those in the embodiment are given the same reference numerals and illustration and description thereof may be omitted.

### First Modification Example of Third Embodiment

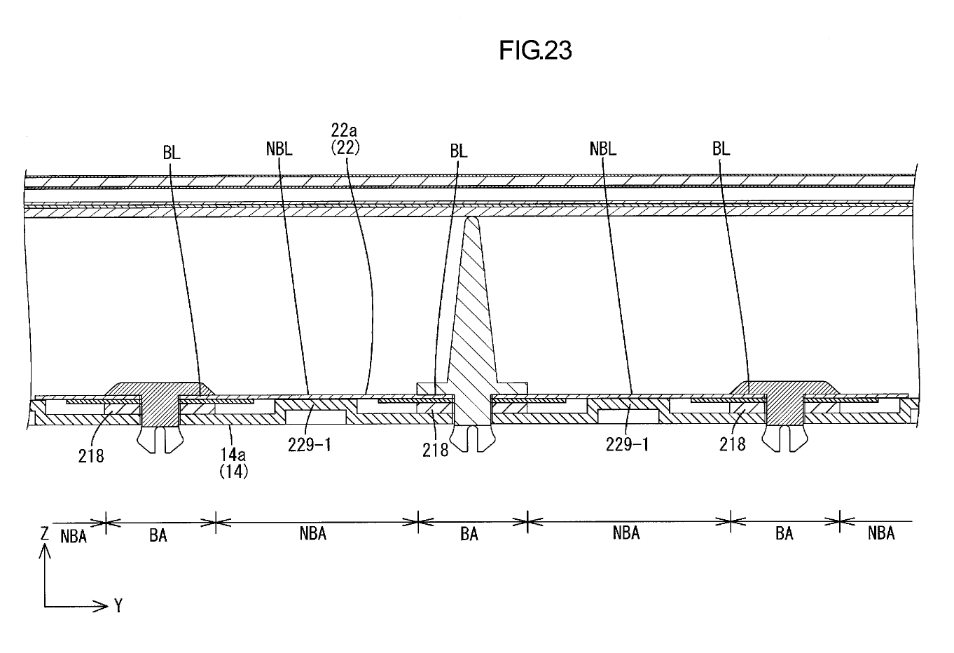

A first modification example of the third embodiment will be described with reference to FIG. 23. Here, a second supporting portion 229-1 having modified configuration is shown.

As shown in FIG. 23, the second supporting portion 229-1 is formed by partially protruding a middle part between the adjacent LED boards 218 in the board non-arrangement area NBA of the bottom plate 14a, and is shaped like a rail having a certain width (width that is narrower than the board non-arrangement area NBA). Describing in detail, the second supporting portion 229-1 has a portal cross section, extends along an outer edge of the LED board 218 and is straight in a plan view. The counter surface (support surface) of the second supporting portion 229-1 facing the first reflection sheet 22 is a flat surface having a constant width and is configured to be in surface-contact with the first reflection sheet 22. With this configuration, the contact area of the second supporting portion 229-1 with the first reflection sheet 22 can be increased from that in the third embodiment and therefore, the first reflection sheet 22 can be supported more stably.

### Fourth Embodiment

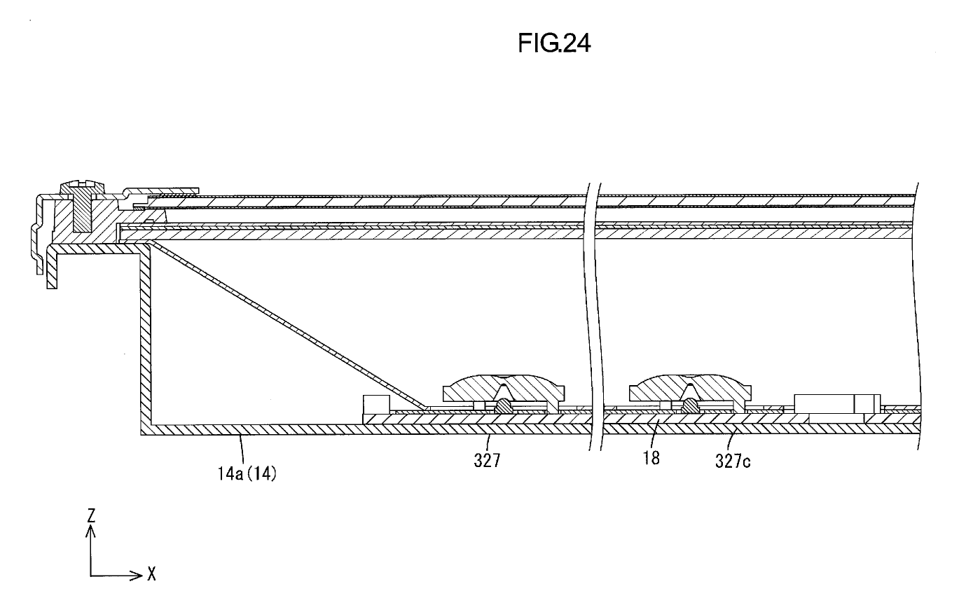

A fourth embodiment of the present invention will be described with reference to FIG. 24. In the fourth embodiment, apart of the board positioning portion in the first embodiment is omitted. Overlapping description of the same configuration, functions and effects as those in the first embodiment is omitted.

As shown in FIG. 24, a board positioning portion 327 is shaped like a rail extending on the bottom plate 14a of the chassis 14 in the X-axis direction. The board positioning portion 327 consists of a side wall part (not shown) extending in the long-side direction of the LED board 18 and a bottom wall part 327c and has no short-side side wall parts 27b as in first embodiment (refer to FIG. 17). Even with this configuration, the LED board 18 can be positioned in the Y-axis direction (short-side direction).

As a matter of course, the configuration according to this embodiment can be applied to the board positioning portion described in the second embodiment.

### Fifth Embodiment

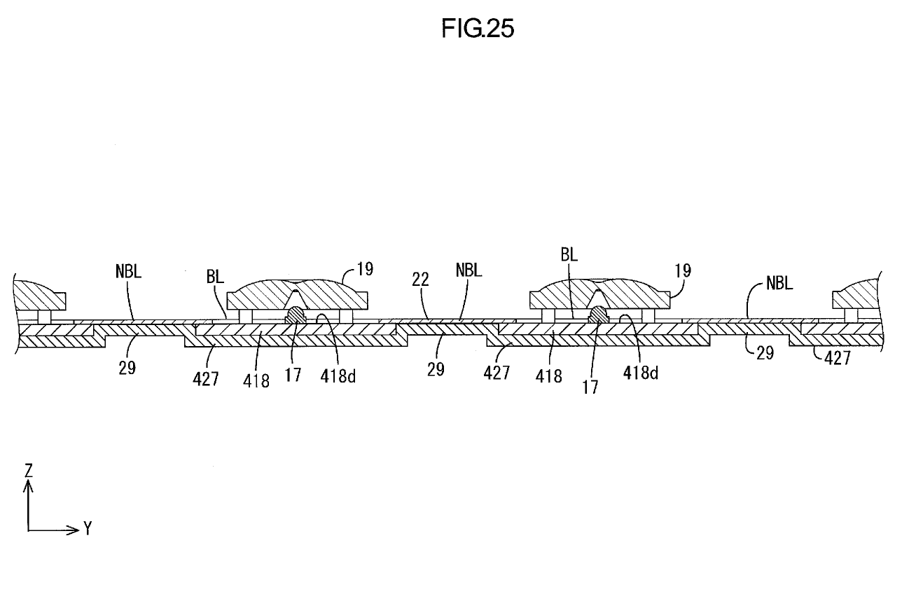

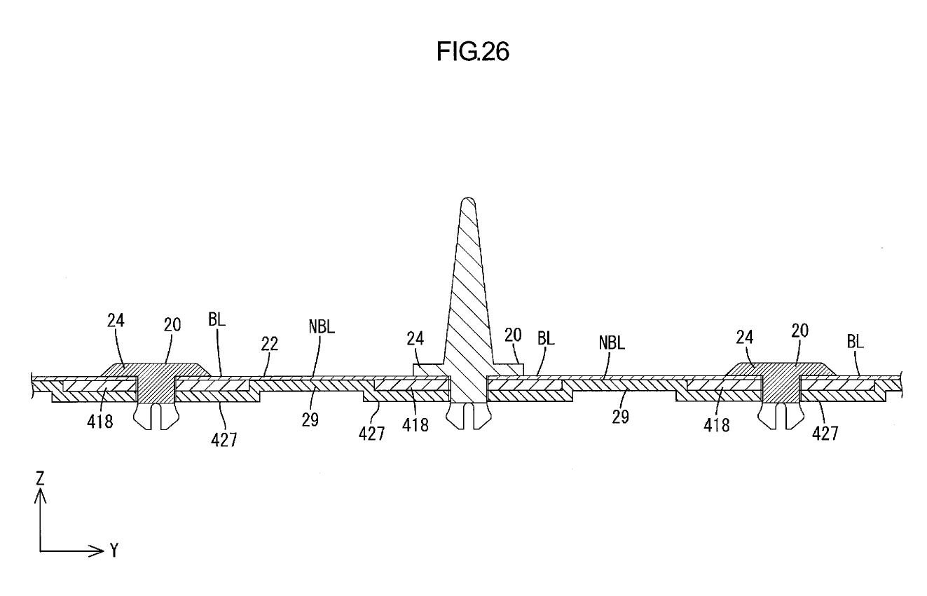

A fifth embodiment of the present invention will be described below with reference to FIG. 25 or FIG. 26. In the fifth embodiment, the second reflection sheet 23 in the first embodiment is omitted. Overlapping description of the same configuration, actions and effects as those in the first embodiment is omitted.

In this embodiment, the second reflection sheet 23 according to the first embodiment is omitted, and as shown in FIG. 25, a reflecting layer 418d in place of the second reflection sheet 23 is formed on the front side surface of an LED board 418. The reflecting layer 418d assumes a white color having excellent light reflectivity, and is formed, for example, by printing paste containing a metal oxide on the surface of the LED board 418. Screen printing and ink jet printing are preferable as printing means. Although the reflecting layer 418d can be formed on the almost entire front side surface of the LED board 418, the reflecting layer 418d may be formed on a part opposite to the diffuser lenses 19 on the LED board 418. The reflecting layer 418d can reflect light returned from the diffuser lenses 19 toward the diffuser lenses 19 again. In this embodiment, the depth dimension of a board positioning portions 427 positioning the LED board 418 is set to be almost equal to the thickness of the LED board 418, so that the front side surface of the LED board 418 and the front side surface of the second supporting portion 29 are in flush with each other and cooperates to support the board overlapping part BL and the board non-overlapping part NBL of the first reflection sheet 22 while maintaining the flatness. As shown in FIG. 26, only the first reflection sheet 22 is sandwiched between the body portion 24 of the holding member 20 and the LED board 418.

### Sixth Embodiment

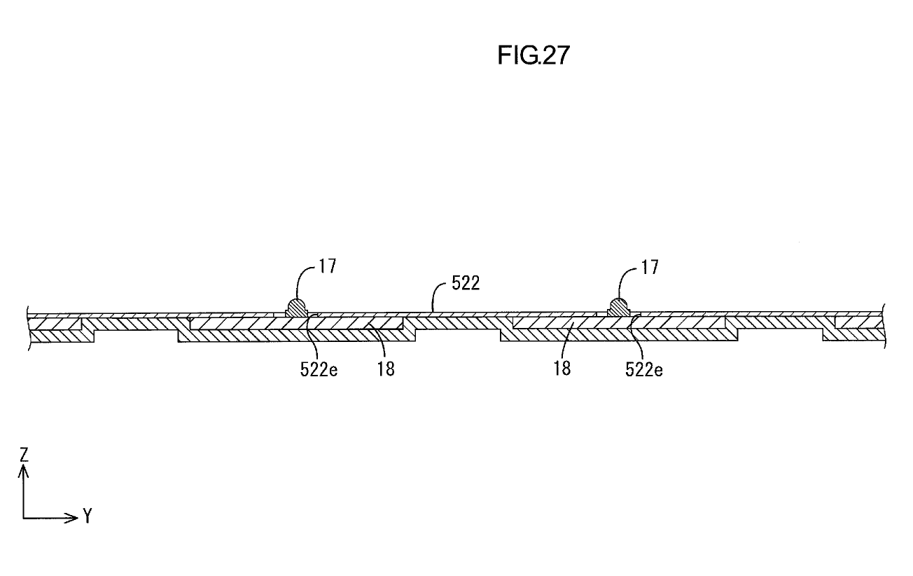

A sixth embodiment of the present invention will be described below with reference to FIG. 27. In the sixth embodiment, the diffuser lenses 19 and the second reflection sheet 23 in the first embodiment are omitted. Overlapping description of the same configuration, actions and effects as those in the first embodiment is omitted.

In this embodiment, since the diffuser lenses 19 and the second reflection sheet 23 in the first embodiment are omitted, light emitted from each of the LEDs 17, as shown in FIG. 28, directly reaches the optical member 15. A first reflection sheet 522 includes an opened LED insertion hole 522e that is configured to pass each of the LEDs 17 therethrough (is smaller than the lens insertion hole 22b in the first embodiment) and can be placed directly on the LED board 18. In adopting this embodiment, since the area between the LEDs 17 is easy to be visually recognized as a dark place, in order to prevent uneven brightness, it is preferred that the alignment pitch of the LEDs 17 in the X-axis direction and the Y-axis direction is smaller than that in the first embodiment.

### Other Embodiments

The present invention is not limited to the embodiments described in the above description and figures, and for example, following embodiments fall within the technical scope of the present invention.

(1) The specific shape of the second supporting portion in each of the above-mentioned embodiments can be appropriately changed. For example, the second supporting portion shaped like a point in a plan view, a curve or a ring having an end (C-shaped) in a plan view, that is, the second supporting portion that does not extend along the outer edge of the LED board also falls within the scope of the present invention. Further, the cylindrical, prismatic, conical or pyramidal second supporting portion, or the second supporting portion having an angular (triangle), semicircular or elliptical cross section also falls within the scope of the present invention.

(2) Arrangement and the number of the second supporting portions in the bottom plate of the chassis in each of the above-mentioned embodiments can be appropriately changed. For example, the second supporting portion eccentrically located near one of the adjacent LED boards in the board non-arrangement area of the bottom plate in a modification example of the third embodiment also falls within the scope of the present invention. The three or more second supporting portions arranged between the adjacent LED boards in the board non-arrangement area in the bottom plate in a modification example of the third embodiment also falls within the scope of the present invention. In the case where the second supporting portion is formed to be point-like or linear in a plan view (is smaller than one side of the LED board), the plurality of second supporting portions can be intermittently arranged in parallel along each side of the LED board.

(3) Although at least a pair of second supporting portions are arranged so as to sandwich the light source board therebetween in a plan view in each of the above-mentioned embodiments, the configuration in which one of the pair of second supporting portion is omitted and the LED board is not sandwiched between the second supporting portions also falls within the scope of the present invention.

(4) As a matter of course, the configuration described in the first and second modification examples can be applied to the second to sixth embodiments.

(5) Positional relationship between the first supporting portion and the second supporting portion in the Z-axis direction in the first and second modification examples of the first embodiment can be changed. For example, contrary to the first and second modification examples of the first embodiment, the front side surface of the second supporting portion, which is arranged closer to the front side (the opening side) than the front side surface of the second reflection sheet, also falls within the scope of the present invention.

(6) Although the short-side side wall parts are omitted from the board positioning portion described in the first embodiment in the fourth embodiment, the configuration in which the long-side side wall parts are omitted from the board positioning portion described in the first embodiment also falls within the scope of the present invention. In omitting the short-side sidewall parts (long-side side wall parts), one of the pair of short-side sidewall parts (long-side side wall parts) sandwiching the LED board therebetween in a plan view can be omitted.

(7) Although the board positioning portion includes the first supporting portion or the second supporting portion in each of the above-mentioned embodiments (except for the third embodiment), the configuration in which the first supporting portion or the second supporting portion is provided separately from the board positioning portion and the board positioning portion does not include the first supporting portion and the second supporting portion also falls within the scope of the present invention.

(8) Although the board positioning portion has almost the same dimension as the LED board in a plan view in each of the above-mentioned embodiments (except for the third embodiment), the specific dimension can be appropriately changed. For example, the board positioning portion may be smaller than the LED board in a plan view and in this case, the plurality of board positioning portions can position one LED board. Conversely, the board positioning portion may be larger than the LED board in a plan view and in this case, one board positioning portion is configured to position the plurality of LED boards together.

(9) The specific shape of the board positioning portion in each of the above-mentioned embodiments (except for the third embodiment) can be appropriately changed. For example, the board positioning portion shaped like a point in a plan view, a curve or a ring having an end (C-shaped) in a plan view, that is, the board positioning portion that does not extend along the outer edge of the LED board also falls within the scope of the present invention. Further, the cylindrical, prismatic, conical or pyramidal board positioning portion, or the board positioning portion having an angular (triangle), semicircular or elliptical cross section also falls within the scope of the present invention.

(10) Although the board positioning portion, the first supporting portion and the second supporting portion are provided integrally with the chassis in each of the above-mentioned embodiments, at least one of the board positioning portion, the first supporting portion and the second supporting portion, which is formed separately from the chassis and then, is assembled to the chassis, also falls within the scope of the present invention.

(11) Although the fixed portion of the holding member passes through the LED board and each of the reflection sheets in each of the above-mentioned embodiments, the configuration in which the holding member is arranged in the board non-arrangement area in the chassis and the fixed portion does not pass through the LED board and the second reflection sheet, but passes through the first reflection sheet also falls within the scope of the present invention.

(12) The attachment positions and the number of holding members with respect to each LED board in each of the above-mentioned embodiments can be appropriately changed. Similarly, the attachment positions and the number of holding members with respect to the chassis can be appropriately changed.

(13) Although the plug-in type fixed portion is adopted as the attachment structure of the holding member to the chassis in each of the above-mentioned embodiments, a slide type may be adopted as the attachment structure. In such slide-type attachment structure, by adopting a hook-type fixed portion, pushing the body portion toward the bottom plate of the chassis and then, sliding the body portion along the bottom plate, the hooked part of the fixed portion is engaged with the edge of the attachment hole.

(14) Although the fixed portion of the holding member is engaged with the chassis through the through hole in each of the above-mentioned embodiments, the specific method of fixing the fixed portion to the chassis can be appropriately changed. For example, the configuration in which the attachment hole and the elastic engaged portion are omitted and a bottom part passing through the through hole of the LED board is fixedly attached to the inner wall surface of the chassis with the adhesive or the like falls within the scope of the present invention. In this case, means such as deposition and welding other than the adhesive can be adopted.

(15) Although the monofunctional holding member and the multifunctional holding member are simultaneously used in each of the above-mentioned embodiments, the configuration using only the monofunctional holding member or only the multifunctional holding member also falls within the scope of the present invention. The ratio of the monofunctional holding member to the multifunctional holding member, which is simultaneously used, can be appropriately changed.

(16) Although the chassis is made of metal in each of the above-mentioned embodiments, the chassis made of other materials such as synthetic resin also falls within the scope of the present invention.

(17) Although the color of the surface of the supporting member is white in each of the above-mentioned embodiments, the color of the surface of the supporting member may be creamy white or silver. Color of the surface can be set by applying paint of a desired color on the surface of the supporting member.

(18) Although the five-mounted type, the six-mounted type and the eight-mounted type of LED boards are combined as appropriate in each of the above-mentioned embodiments, an LED board that mounts the number of LEDs other than five, six and eight LEDs falls within the scope of the present invention.

(19) Although the LED that includes the LED chip that emits only blue light and emits white light by means of the phosphor is used in each of the above-mentioned embodiments, an LED that includes the LED chip that emits only ultraviolet light and emits white light by means of the phosphor falls within the scope of the present invention.

(20) Although the LED that includes the LED chip that emits only blue light and emits white light by means of the phosphor is used in each of the above-mentioned embodiments, an LED that has three types of LED chips that emit R, G, B, respectively, falls within the scope of the present invention. Moreover, an LED that has three types of LED chips that emit C (cyan), M (magenta), Y (yellow), respectively, also falls within the scope of the present invention.

(21) Although the LED that emits white light in each of the above-mentioned embodiments, an LED that emits red light, an LED that emits blue light and an LED that emits green light may be combined as appropriate.

(22) Although the LED is used as the light source in each of the above-mentioned embodiments, a point light source other than the LED also falls within the scope of the present invention.

(23) Although the diffuser lens that diffuses light from the LED is used in the first to fifth embodiments, an optical lens other than the diffuser lens (for example, a collective lens) falls within the scope of the present invention.

(24) Also in embodiments other than each of the above-mentioned embodiments, screen size and aspect ratio of the liquid crystal display device can be changed as appropriate.

(25) Although the liquid crystal panel and the chassis are arranged in the longitudinally mounted state so that the short-side direction matches the vertical direction in each of the above-mentioned embodiments, the configuration in which the liquid crystal panel and the chassis are arranged in the longitudinally mounted state so that the long-side direction matches the vertical direction also falls within the scope of the present invention.

(26) Although the TFT is used as the switching component of the liquid crystal display device in each of the above-mentioned embodiments, the present invention can also be applied to a liquid crystal display device using a switching component (for example, a thin film diode (TFD)) other than TFT and the monochrome liquid crystal display device other than the color liquid crystal display device.

(27) Although the liquid crystal display device using the liquid crystal panel as the display panel is illustrated in each of the above-mentioned embodiments, the present invention can be applied to a display device using the other type of display panel.

(28) Although the television receiver having a tuner is illustrated in each of the above-mentioned embodiments, the present invention can be applied to a display device having no tuner.

1. A lighting device comprising:
a light source board including a light source;
a chassis storing the light source board therein and has an opening through which light from the light source exits; and
a reflection member arranged on an opening side so as to overlap the light source board in a plan view, the reflection member being larger than the light source board and configured to reflect light,
wherein the chassis has a first supporting portion that supports the light source board and a second supporting portion that is arranged closer to the opening than the first supporting portion and supports the reflection member.

2. The lighting device according to claim 1, wherein the second supporting portion includes at least a pair of second supporting portions arranged so as to sandwich the light source board therebetween in a plan view.

3. The lighting device according to claim 1, wherein:
the light source board includes a plurality of light source boards arranged parallel to one another at predetermined intervals; and
the second supporting portion is arranged between the adjacent light source boards.

4. The lighting device according to claim 3, wherein the second supporting portion covers an entire area between the adjacent light source boards.

5. The lighting device according to claim 3, wherein the second supporting portion is arranged at about the midpoint position of the adjacent light source boards.

6. The lighting device according to claim 1, wherein the second supporting portion extends along an outer edge of the light source board.

7. The lighting device according to claim 6, wherein:
the light source board is rectangular in a plan view; and
the second supporting portion extends in a long-side direction of the light source board.

8. The lighting device according to claim 6, wherein the second supporting portion surrounds the light source board.

9. The lighting device according to claim 1, wherein the second supporting portion is in flush with an opposite surface of the light source board to the reflection member.

10. The lighting device according to claim 1, wherein the first supporting portion is formed by protruding a part of the chassis toward a side opposite to the opening.

11. The lighting device according to claim 1, wherein the second supporting portion is formed by protruding a part of the chassis toward the opening.

12. The lighting device according to claim 1, wherein the chassis includes a board positioning portion configured to position the light source board along a plate surface of the light source board.

13. The lighting device according to claim 12, wherein the board positioning portion extends along the edge of the light source board.

14. The lighting device according to claim 13, wherein:
the light source board is rectangular in a plan view; and
the board positioning portion extends along the long-side direction of the light source board.

15. The lighting device according to claim 12, wherein the board positioning portion is configured to position the light source board in two directions that are along a plate surface and are perpendicular to each other.

16. The lighting device according to claim 12, wherein the board positioning portion includes either the first supporting portion or the second supporting portion.

17. The lighting device according to claim 16, wherein:
the board positioning portion includes a board storing space and the first supporting portion, the board storing space being formed by protruding a part of the chassis toward the side opposite to the opening and in which the light source board is stored.

18. The lighting device according to claim 16, wherein the board positioning portion is prepared by protruding a part of the chassis toward the opening and includes the second supporting portion.

19. The lighting device according to claim 1, wherein the reflection member has a light source insertion hole in an area overlapping the light source in a plan view and through which the light source is passed.

20. The lighting device according to claim 19, further comprising a diffuser lens arranged on the light source board in an area overlapping the light source in a plan view and configured to reflect light from the light source.

21. The lighting device according to claim 20, wherein:
the reflection member includes a first reflection member and a second reflection member, the first reflection member having the light source insertion hole through which the diffuser lens is passed, the second reflection member being arranged between the light source board and the diffuser lens so as to overlap the light source insertion hole of the first reflection member in a plan view and being configured to reflect light toward the diffuser lens; and
the second supporting portion supports the first reflection member.

22. The lighting device according to claim 21, wherein: the second reflection member is placed on the light source board on the opening side;
the first reflection member is placed on the second reflection member on the opening side; and
the second supporting portion is in flush with an opposite surface of the second reflection member to the first reflection member.

23. The lighting device according to claim 21, wherein the light source insertion hole of the first reflection member and the second reflection member are formed such that an edge of the light source insertion hole and the second reflection member overlap each other in a plan view.

24. The lighting device according to claim 1, further comprising a holding member holding the light source board and the reflection member between the holding member and the chassis.

25. The lighting device according to claim 24, wherein the holding member includes a body portion and a fixed portion, the body portion holding the light source board and the reflection member together with the chassis between the body portion and the chassis, the fixed portion protruding from the body portion toward the chassis and being passed through the light source board and the reflection member, and being fixed to the chassis.

26. The lighting device according to claim 25, wherein the fixed portion is passed through the light source board, the reflection member, and the chassis, and is engaged with the chassis from the side opposite to the light source board.

27. The lighting device according to claim 1, wherein the light source is an LED.

28. A display device comprising the lighting device according to claim 1 and a display panel configured to provide display using light from the lighting device.

29. The display device according to claim 28, wherein the display panel is a liquid crystal panel including liquid crystals between a pair of substrates.

30. A television receiver comprising the display device according to claim 28.
